(19) United States
(12) Patent Application Publication
(10) Pub. No.: US 2006/0293933 A1
(43) Pub. Date: Dec. 28, 2006

(54) Engineering method and tools for capability-based families of systems planning

(75) Inventors: Paul Tyson Millhouse, Purcellville, VA (US); Jacqueline Owens Lancaster, Leonardtown, MD (US); Charles Everett Dickerson, Alexandria, VA (US); George Kim, Fairfax, VA (US); Kevin Reed Shaw, Fairfax, VA (US)

Correspondence Address: GREENBERG-TRAURIG, 1750 TYSONS BOULEVARD, 12TH FLOOR, MCLEAN, VA, 22102, US

(73) Assignee: BAE Systems National Security Solutions, Inc., Reston, VA (US)

(21) Appl. No.: 11/430,176

(22) Filed: May 9, 2006

Related U.S. Application Data
(60) Provisional application No. 60/692,622, filed on Jun. 22, 2005.

(51) Int. Cl. G06F 9/44

(52) U.S. Cl. 705/7

(57) ABSTRACT

A method of enhancing capabilities is provided. A family of systems capability and operational analysis is conducted to generate a set of operationally decomposed capability needs. Further, a family of systems functional analysis and allocation is conducted on the set of operationally decomposed capability needs to determine a set of deficiencies. In addition, a family of systems design synthesis is conducted on the set of operationally decomposed capability needs, a set of existing solutions, and a set of emerging solutions to identify and describe an optimal integrated solution set of existing solutions and emerging solutions to satisfy the set of operationally decomposed capability needs. Further, the optimal integrated solution set of existing solutions and emerging solutions is generated from the family of systems design synthesis.

### RELATED APPLICATION

This application claims the benefit of and priority to U.S. Provisional Application Ser. No. 60/692,622, entitled Engineering Method And Tools For Capability-Based Families of Systems Planning, filed Jun. 22, 2005, the contents of which, including its appendices, are incorporated by reference herein in their entirety.

### BACKGROUND

1. Field

A system and method are disclosed which generally relate to capability-based planning for families of systems.

2. General Background

As organizations expand and mature, they face a variety of problems that must be solved. In large organizations, different segments may face similar or overlapping problems at the same or different times. Frequently, these segments will attempt to solve the problems themselves without coordinating with other segments that have developed solutions to address similar problems. As a result, a large number of unnecessary redundancies can be created within the organization and throughout related organizations. Efficiency is significantly hampered by these unnecessary redundancies.

Demand for efficiency throughout a large base of technology is currently being felt across large organizations. For instance, federal, state, and local agencies are attempting to share data and services across organizational boundaries to better improve efficiency. Large industries are also beginning to move in the same direction.

With the strong desire for interoperation among systems comes the assumption that there are solutions that can facilitate the interoperation. However, the standard solutions cannot effectively facilitate the interoperation.

Organizations utilize their capabilities, or their ability to deliver a desired effect or outcome through a combination of processes and solutions. Such capabilities can be provided by a combination of business processes, human agents, and technology, working together to satisfy the organization's mission.

For most organizations, survival depends on the ability to create, evolve, adapt, or improve capabilities to meet changing needs. Anticipating and providing capabilities to meet emerging capability needs therefore becomes essential to future success. However, the extremely complex environments in which many organizations operate make anticipating such emerging capability needs very difficult.

Organizational capabilities are seldom provided by single solutions. Typically they involve a collection of business processes, people, and systems, working in concert to achieve the desired outcome. In an environment of constant change, systems that previously were not intended to work together may be called upon to work collectively to satisfy an urgent capability need. Existing systems and methodologies are not equipped to determine the most efficient solutions for a complex environment.

### SUMMARY

In one aspect of the disclosure, a method of enhancing capabilities is disclosed. A family of systems capability and operational analysis is conducted to generate a set of operationally decomposed capability needs. Further, a family of systems functional analysis and allocation is conducted on the set of operationally decomposed capability needs to determine a set of deficiencies. In addition, a family of systems design synthesis is conducted on the set of operationally decomposed capability needs, a set of existing solutions, and a set of emerging solutions to identify and describe an optimal integrated solution set of existing solutions and emerging solutions to satisfy the set of operationally decomposed capability needs. Further, the optimal integrated solution set of existing solutions and emerging solutions is generated from the family of systems design synthesis.

In another aspect of the disclosure, a method of enhancing capabilities is disclosed. A family of systems capability and operational analysis is conducted to generate a set of operationally decomposed capability needs. Further, a family of systems functional analysis and allocation is conducted on the set of operationally decomposed capability needs to determine a set of deficiencies. In addition, a family of systems design synthesis is conducted on the set of operationally decomposed capability needs, a set of existing solutions, and a set of emerging solutions. Further, a plot is created from the family of systems design synthesis that illustrates one or more desirable integrated solution sets of existing solutions and emerging solutions. Finally, an optimal integrated solution set of existing solutions and emerging solutions is determined, from the plot, to satisfy the set of operationally decomposed capability needs.

In yet another aspect of the disclosure, a method of enhancing capabilities is disclosed. A family of systems capability and operational analysis is conducted to generate a set of operationally decomposed capability needs. Further, a family of systems functional analysis and allocation is conducted on the set of operationally decomposed capability needs to determine a set of deficiencies. In addition, a family of systems design synthesis is conducted on the set of operationally decomposed capability needs, a set of existing solutions, and a set of emerging solutions. Further, a matrix is created from the family of systems design synthesis that illustrates one or more desirable integrated solution sets of existing solutions and emerging solutions. Finally, an optimal integrated solution set of existing solutions and emerging solutions is determined, from the matrix, to satisfy the set of operationally decomposed capability needs.

In another aspect of the disclosure, a method of enhancing capabilities is disclosed. An architecture model of an operating environment is created. Further, a family of systems capability and operational analysis is conducted on data from the architecture model using simulation and analysis to generate a set of operationally decomposed capability needs. In addition, a family of systems functional analysis and allocation is conducted on the set of operationally decomposed capability needs and data from the architecture model using simulation and analysis to determine a set of deficiencies. Further, a family of systems design synthesis is conducted on the set of operationally decomposed capability needs, a set of existing solutions, a set of emerging solutions, and data from the architecture model using simulation and analysis to identify and describe an optimal integrated solution set of existing solutions and emerging solutions to satisfy the set of operationally decomposed capability needs. Finally, the optimal integrated solution set of existing solutions and emerging solutions is generated from the family of systems design synthesis.

### DRAWINGS

The above-mentioned features and objects of the present disclosure will become more apparent with reference to the following description taken in conjunction with the accompanying drawings wherein like reference numerals denote like elements and in which:

FIG. 1 illustrates a mapping of components for a capability.

FIG. 2A illustrates an example scenario that can benefit from Capability Planning.

FIG. 2B illustrates a top down view of the example scenario illustrated in FIG. 2A.

FIG. 3 illustrates a block diagram of a customer's capability needs.

FIG. 4 illustrates a block diagram of the activities associated with the first capability.

FIG. 5 illustrates a block diagram of a first activity sequence for the first capability.

FIG. 6 illustrates a block diagram of a second activity sequence for the first capability.

FIG. 7 illustrates a block diagram of a plurality of potential activity sequences for the capability.

FIG. 8 illustrates a block diagram of the functions associated with an activity.

FIG. 9 illustrates a block diagram of a function sequence for the first activity.

FIG. 10 illustrates a block diagram of another potential function sequence for the first activity.

FIG. 11 illustrates the block diagram of FIG. 7 with an expanded illustration of the first activity sequence.

FIG. 12 illustrates a block diagram for candidate integrated solution sets.

FIG. 13 illustrates a Family of Systems Systems Engineering method of enhancing capabilities.

FIG. 14 illustrates a block diagram for the family of systems capability and operational analysis.

FIG. 15 illustrates a block diagram for the family of systems functional analysis and allocation in which an activity is decomposed into at least one function sequence.

FIG. 16 illustrates a matrix for the family of systems functional analysis and allocation in which a determination is made for each function as to what existing solutions can provide the function.

FIG. 17 illustrates a matrix that is utilized in the family of systems design synthesis.

FIG. 18 illustrates an Integrated Solution Set matrix.

FIG. 19 illustrates a plot which can be utilized to determine the subset of candidate ISSs.

FIG. 20 illustrates a process for enhancing capabilities.

FIG. 21 illustrates a process for enhancing capabilities.

FIG. 22 illustrates a process for enhancing capabilities.

### DETAILED DESCRIPTION

A capability is the ability to achieve a desired effect or outcome under specified standards and conditions through combinations of processes and solutions. An organization utilizes its capabilities to perform its mission or achieve some objective within the scope of the organization's mission. Capabilities should be composable so that they can be combined in various ways to achieve larger effects. For example, many organizations have a finance capability that builds on smaller-grained capabilities that include accounting, procurement, management reporting, and corporate communications. Further, capabilities should be decomposable so that the analysis can be performed on the sub-components of the capability to determine the best solutions for the capabilities.

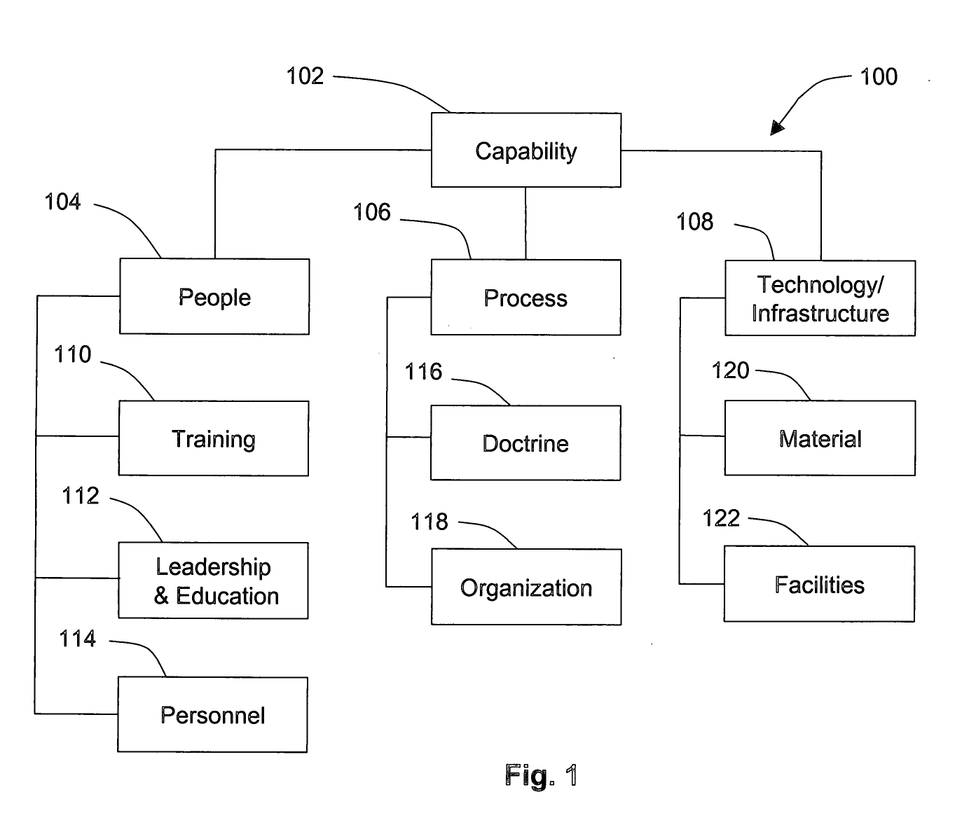

FIG. 1 illustrates a mapping 100 of components for a capability 102. The capability 102 is provided by people 104, process 106, and technology/infrastructure 108. The people 104 is a component that includes sub-components such as training 110, leadership & education 112, and personnel 114. Further, the process 106 is a component that includes a doctrine 116 and organization 118. In addition, the technology/infrastructure 108 is a component that includes materiel 120 and facilities 122. In essence, the role of the technology/infrastructure 108 in capabilities is to support the people 104 performing the associated processes 106.

The capability 102 can be realized in many possible ways by utilizing different combinations and relative amounts of the components. For example, rather different capability realizations that satisfy the same capability need can be achieved by varying the relative amounts of manual activity (the people 104 and the process 106) and automated support (the technology/infrastructure 108).

Each distinct capability realization has its own particular set of costs, performance, effectiveness, and other attributes. If, for example, the capability 102 is realized by entirely manual activities, the implementation cost includes the cost of developing, maintaining, and delivering training for the personnel 114 involved in performing the processes 106. The operating cost is the cost of labor and supplies. On the other hand, the same capability need might be satisfied by completely automatable solutions. In that case, the implementation costs associated with constructing or integrating automated support are higher than for the manual implementation, but the operating costs could be negligible. Accordingly, it is also possible for capability realizations to achieve the same results yet with very different components.

The capabilities 102 have associated measures of effectiveness (“MOEs”), which are the measures by which an organization gauges successful execution of its capabilities. MOEs are utilized to assess the adequacy of components that are utilized for the capability 102. The MOEs can be determined for a specific objective. MOEs include measures such as cycle time for a repeated process, number of outputs per unit time, or defect rates in production. The MOEs for the capability should remain unchanged regardless of how the implementation for the capability 102 is modified, i.e., if a different combination of relative amounts of the components of the capability 102 is utilized.

Measures of Performance (“MOPs”) are the attributes of systems or equipment that affect capability effectiveness. The technology/infrastructure 108 is a component that can contribute to the overall capability effectiveness. Accordingly, the materiel 120 and the facilities 122 are sub-components that can contribute to capability effectiveness. MOPs are measurable physical quantities such as speed, range, or frequency.

In most Capability Planning (“CP”) scenarios, there is an existing base of technology that supports existing capabilities. The CP mission is to assess the customer's current capability needs and identify possible routes to improved capabilities for these CP scenarios. The possible routes may require changes in technology to integrate new and existing solutions. The capabilities affected must evolve and continue to fit seamlessly into a larger context.

The relevant terms used throughout the description are defined below.

A family-of-systems (“FoS”) is a set of independent, rather than interdependent, systems that can be arranged or interconnected to work together to provide capabilities. The component systems within the FoS may not specifically be designed to work together. The component systems may even be incompatible. These complications may arise because the component systems are likely to be owned by different entities within one or more organization that are not configured to work together.

A system-of-systems (“SoS”) is a set of interdependent systems that are designed to work together. The interdependent systems are designed to be compatible with one another even if they are constructed by different organizations. For instance, the systems in an aircraft can be very complex SoSs that are manufactured by different organizations, but are designed to work together.

Family of Systems Systems Engineering (“FoSSE™”) is the engineering of a FoS to achieve specified mission capabilities through the individual operation and collective interoperation of the systems in the family. The analysis and decision support techniques embodied in the FoSSE™ are described herein. These analysis and decision support techniques are designed to uncover the incompatibilities among FoS member systems as they affect specific uses of the FoS. Further, a mapping of the paths by which these incompatibilities could be resolved is created.

Interoperability is defined as the ability of systems or organizations to share information or services to enable effective function/operation. Within an SoS, the SoS member systems are designed to interoperate. Further, the SoS member systems generally and deliberately evolve in ways that support their interoperation. In contrast, FoS member systems are not necessarily designed to interoperate; they are likely to be owned and operated by different entities or organizations and to be on entirely different evolutionary trajectories.

Abstract Functions are functions defined based on a transformation of the operational activities associated with a capability. Given infinite resources, these abstract functions might ultimately be implemented to support a capability. The CP expectation is that these abstract functions will be mapped to existing materiel or non-materiel support and/or mapped to functions already provided by Commercials Off the Shelf (“COTS”) or other solutions. In many cases, the actual implemented function will not have been designed to support the abstract function. In best cases, the abstract function can be provided by some feasible combination of implemented functions.

Function Classes are groupings of abstract functions that may be used to improve manageability in CP when the problem scope is very large. Function classes are intended to preserve meaning and reduce the amount of manual labor in CP when used appropriately.

A solution is a manual activity, system, service, application, COTS product, proposed development, or other capability fragment offered as a response to required functionality or interoperability.

Implemented functions are the functions defined and provided by solutions.

Function sequencing is an extended scenario as defined in operational terms and carried to a solutions level. Function sequencing can cross solution boundaries. The objective is to uncover interfaces and dependencies that must be taken into account during CP for interoperability considerations or for estimating measures of performance.

Static analysis is the set of non-simulation based techniques used to identify FoS deficiencies.

Dynamic analysis is the set of simulation based techniques used to evaluate FoS performance characteristics.

Capability analysis is a set of activities CP may leverage to take in architecture descriptions, user requests, strategic intent, and generate prioritized capability needs and operational concepts.

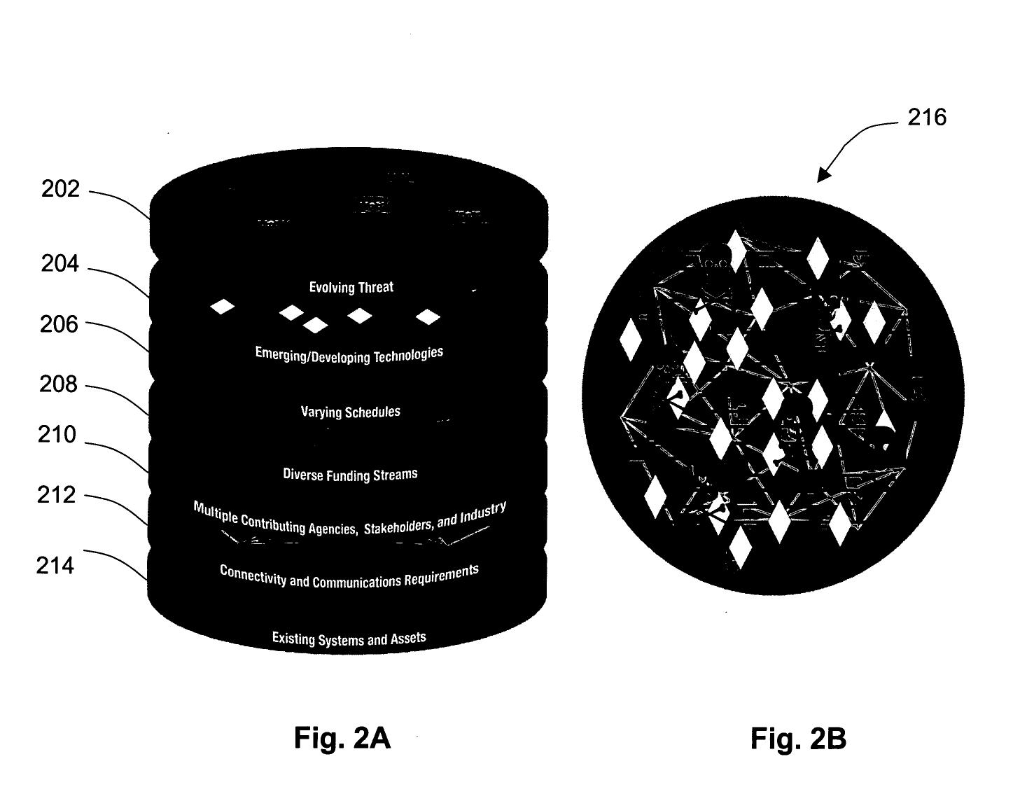

FIG. 2A illustrates an example scenario that can benefit from CP. The scenario involves a plurality of components that, when combined, provide highly complex challenges. The components can include, for example, an evolving threat 202, an emerging/developing technologies 204, varying schedules 206, diverse funding streams 208, multiple contributing agencies, stakeholders, and industry 210, and connectivity and communications requirements 212, and existing systems and assets 214. Advances in technology have led to linking systems and processes in ways that were never previously considered. As a result, order-of-magnitude increases in capability are possible. However, as can be seen from the components in FIG. 2A, there are also order-of-magnitude increases in the complexity of integrated and interoperable Families of Systems (“FoSs”). For instance, connectivity and communications 212 must be provided to existing systems and assets 214. Further, the emerging/developing technologies 204 must be identified. In addition, changes to the evolving threat 202 must be responded to. Further, the contributing agencies, stakeholders, and industry 210 all contribute to the materiel 120 (FIG. 1) and the non-material elements (FIG. 1) that comprise the FoS and that each have separate funding streams 208 and schedules 206. Solving any one issue presents a challenge, but to deliver interoperable FoSs, the issues must be addressed collectively. Without a rigorous methodology for considering the materiel and non-materiel and addressing all issues contributing to complexity, the optimal solution is difficult, if not impossible, to determine.

FIG. 2B illustrates a top down view 216 of the example scenario illustrated in FIG. 2A. Each different layer in the top down view 216 has a level of complexity. Further, the interaction between the different layers provides another level of complexity.

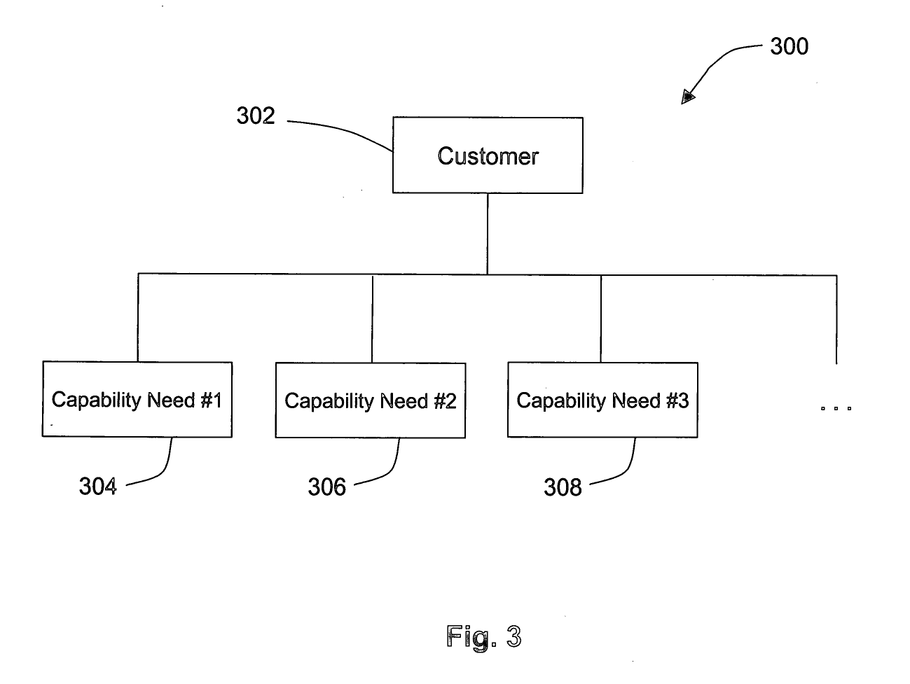

FIG. 3 illustrates a block diagram 300 of a customer's 302 capability needs. At the outset, the customer 302 provides the capabilities that the customer 302 has or would like to have. The customer 302 can enumerate a first capability need 304, a second capability need 306, a third capability need 308, etc. The customer may require a small or a large number of capabilities. For complex customer missions, the number of capabilities required by the customer 302 will often be quite large. The customer 302 will want to know the most optimal set of solutions for each of these capabilities. The optimal set of solutions can include solutions that the customer already has, solutions that the customer needs to obtain, or a combination of both.

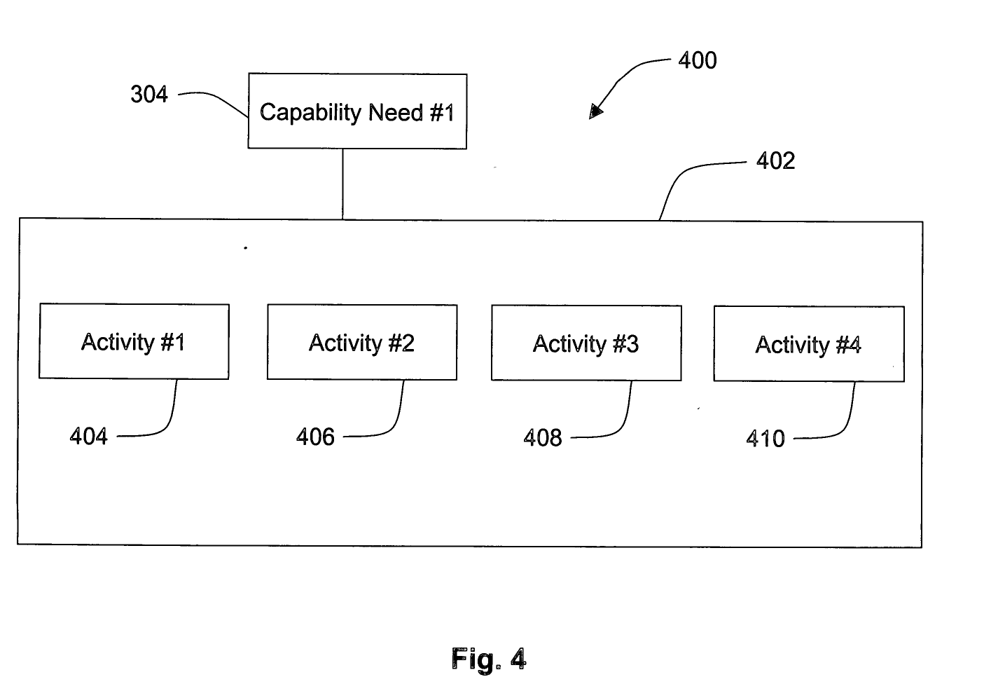

FIG. 4 illustrates a block diagram 400 of the activities associated with the first capability need 304. The first capability need 304 is used merely as an example capability need. The block diagram 400 is applicable to capabilities in general.

The first capability need 304 is satisfied through a collection of potential activities 402. A subset of the collection of potential activities 402 may ultimately be utilized for the final solution that satisfies the first capability need 304. Accordingly, the collection of activities 402 includes a first activity 404, a second activity 406, a third activity 408, and a fourth activity 410. While a complex system will normally include many more activities than those illustrated in FIG. 4, the first activity 404, the second activity 406, the third activity 408, and the fourth activity 410 shall be helpful in illustrating the composition of the first capability need 304.

The first activity 404, the second activity 406, the third activity 408, and the fourth activity 410 are essentially the sub-components of the first capability need 304. As an example, the first capability need 304 may be to provide transatlantic communication. The first activity 404, the second activity 406, the third activity 408, and the fourth activity 410 are the sub-components, i.e., the processes, hardware, and software that can be utilized to provide transatlantic communication. For instance, the first activity 404 may be transmitting data. Further, the second activity 406 may be relaying data from space. In addition, the third activity 408 may be receiving data. Finally, the fourth activity 410 may be relaying data from a ground transmission.

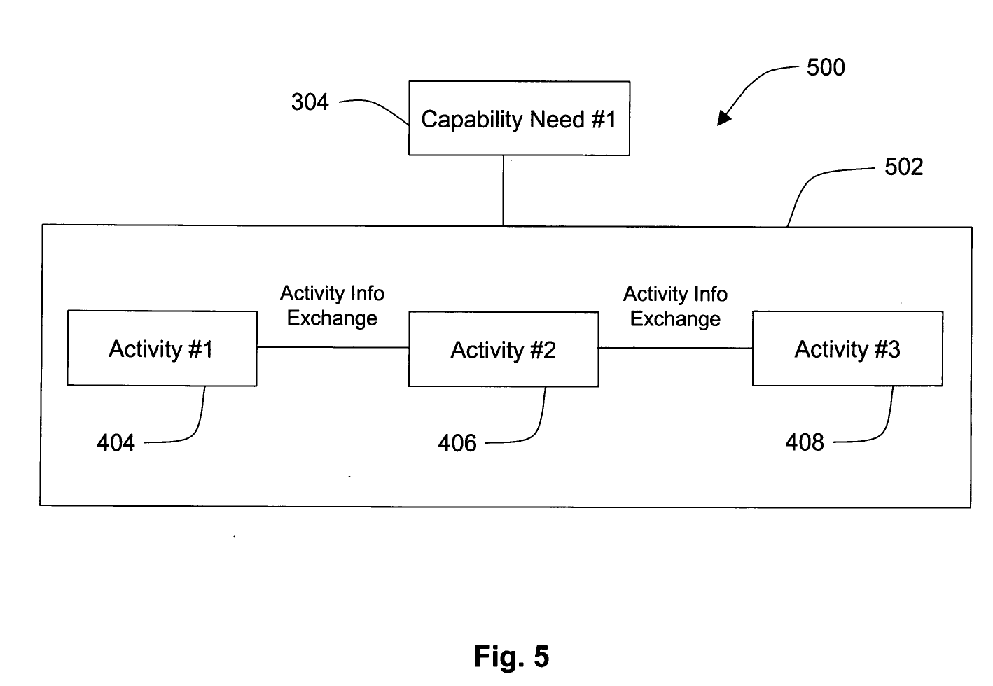

FIG. 5 illustrates a block diagram 500 of a first activity sequence 502 for the first capability need 304. The first activity 404 has an activity information exchange with the second activity 406. Subsequently, the second activity 406 has an activity information exchange with the third activity 408. In the example provided above, the first activity 404 of transmitting data can occur first in the first activity sequence 502. Subsequently, the second activity 406 of relaying data from space can occur second. Finally, the third activity 408 of receiving data can occur third.

A variety of potential activity sequences may be provided for the first capability need 304. The activity sequences may even change in real time to address capabilities that need to change very quickly. For instance, a capability may be needed to address a complex problem such as the evolving threat 202 (FIG. 2). The variables for the evolving 202 threat may change instantaneously. In addition, the interaction between the activities are not restricted to a linear format. In a complex environment, one activity may be interacting with multiple activities at different times. Further, one activity may interact with one or more other activities simultaneously. One activity may also be initiated prior to the completion of another activity.

The customer's 302 infrastructure may also change frequently, thereby leading to different potential activity sequences. In other words, the customer 302 may have more or less resources such that the interaction between the activities changes.

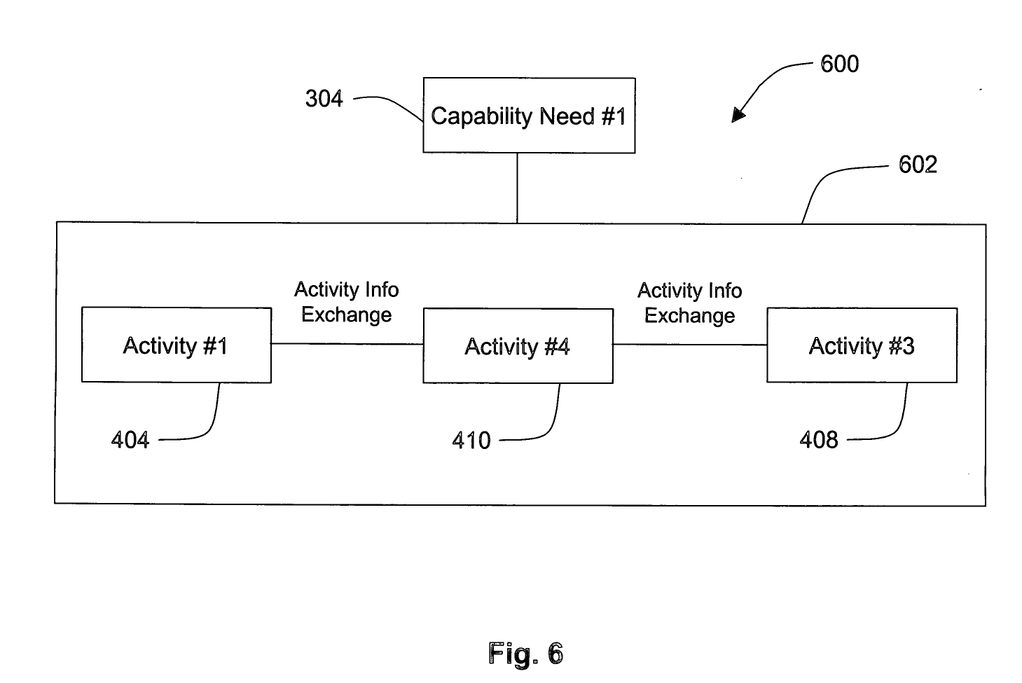

FIG. 6 illustrates a block diagram 600 of a second activity sequence 602 for the first capability need 304. The first activity 404 has an activity information exchange with the second activity 406. Subsequently, the fourth activity 410 has an activity information exchange with the third activity 408. In the example provided above, the first activity 404 of transmitting data can occur first in the first activity sequence 502. Subsequently, the fourth activity 410 of relaying data from a ground transmission can occur second. Finally, the third activity 408 of receiving data can occur third.

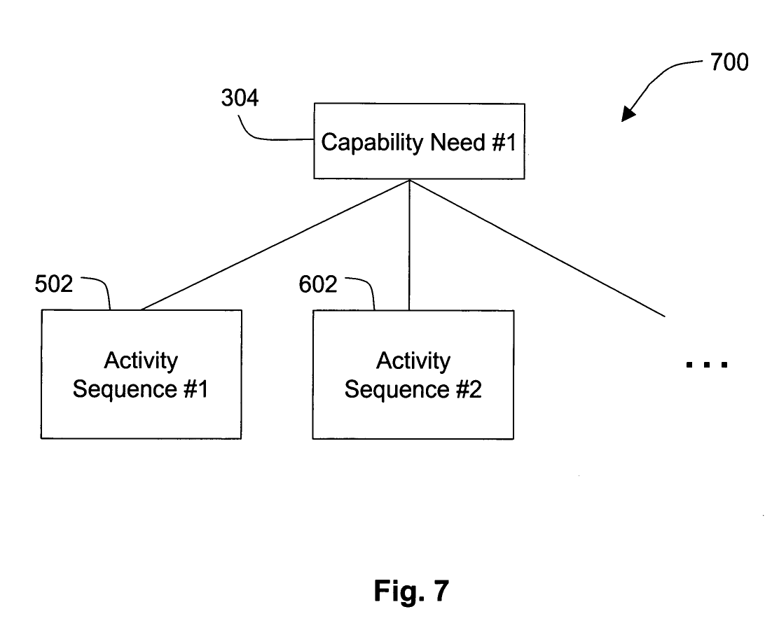

FIG. 7 illustrates a block diagram 700 of a plurality of potential activity sequences for the capability first 304. The first activity sequence 502, the second activity sequence 602, and other potential activity sequences can be utilized to provide the first capability need 304. Each of the potential activity sequences will provided to an analytical engine to a determine an optimal integrated solution set of existing and emerging solutions for each of the activity sequences. From the set of optimal integrated solution sets, an optimal integrated solution set and associated activity sequence can be chosen that is the best set integrated solution set for the first capability need 304.

The optimal integrated solution set is also called a Recommended Integrated Solution Set. The optimal integrated solution set is an optimized set of interoperable legacy and new materiel and non-materiel solutions that will satisfy the customer's capability need(s). Accordingly, the optimal integrated solution set provides a basis for subsequent budget development and more detailed solution engineering, development, integration, test, operations, and sustainment efforts.

The process of analyzing each activity sequence to find the optimal integrated solution set for that activity sequence involves an analysis of the functions of each activity in the activity sequence. A function is a sub-component of an activity.

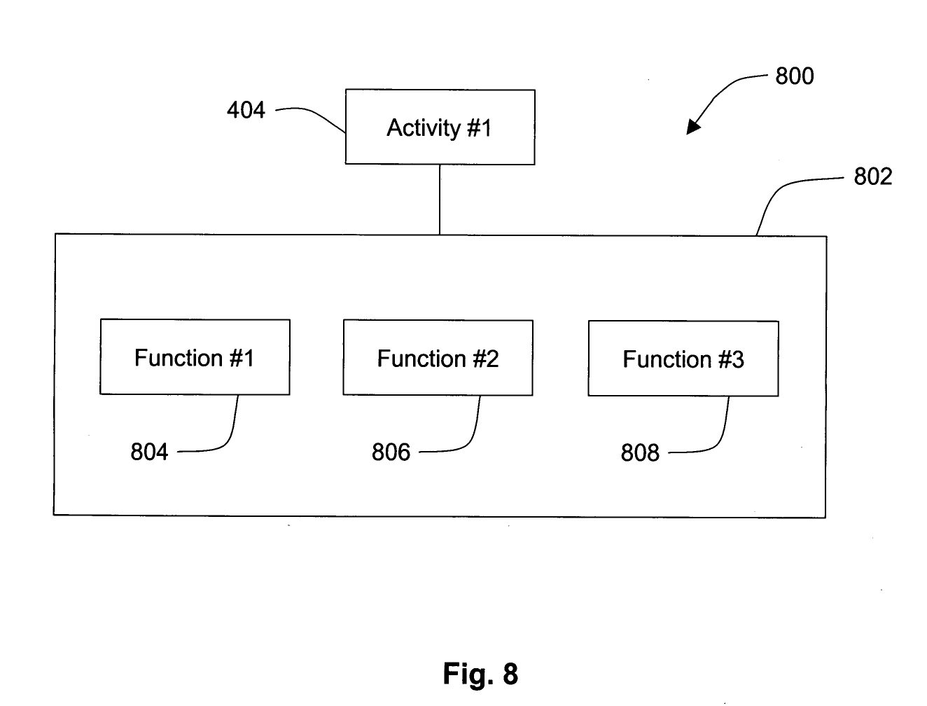

FIG. 8 illustrates a block diagram 800 of the functions associated with an activity 802. The activity 802 can be an activity in first activity sequences such as the activity sequence 502 (FIG. 5) or the second activity sequence 602 (FIG. 6). The activity 802 includes a collection of functions 802, such as a first function 804, a second function 806, and a third function 808. In the example above, the first activity 404 was transmitting data. The first function 804 can be generating a digital signal. Further, the second function 806 can be encrypting the digital signal. Finally, the third function 808 can be storing the digital signal.

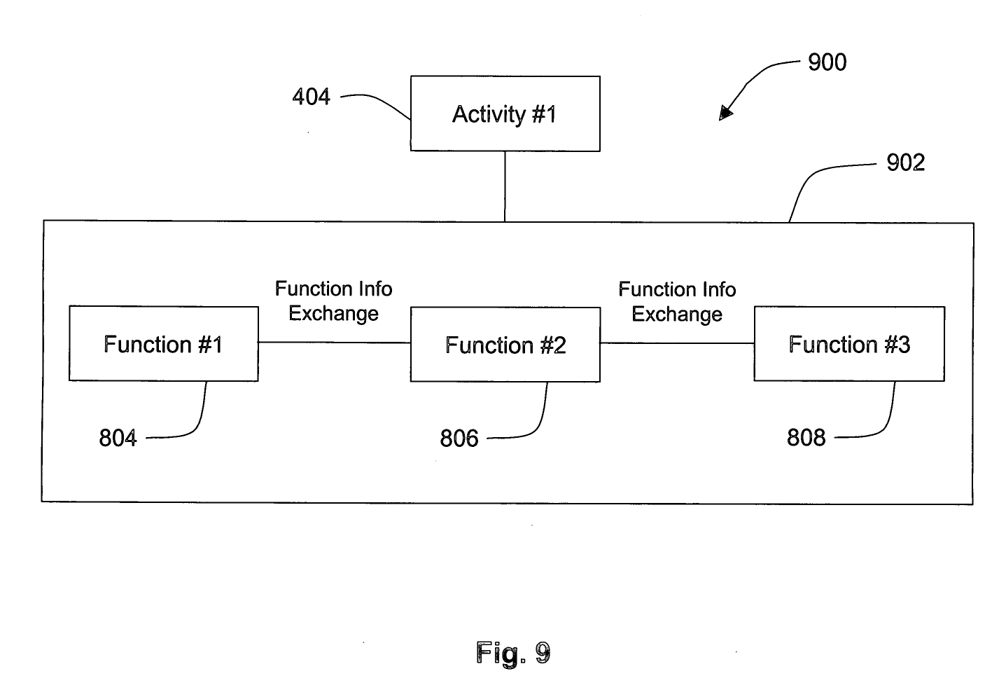

FIG. 9 illustrates a block diagram 900 of a function sequence 902 for the first activity 404. The first function 804 exchanges function information with the second function 806. Subsequently, the second function 806 exchanges function information with the third function 808. In the example provided, the first function 804 of generating the digital signal can occur first. Further, the second function 806 of encrypting the digital signal can occur second. Finally, the third function 808 of storing the digital signal can occur third. In this instance, the digital signal that is stored is encrypted.

A variety of other potential function sequences are possible. Further, the relationship between function sequences is not limited to a linear relationship. In other words, one function may interact with multiple functions. Further, one function may occur before another in the function sequence. A function may occur simultaneously with one or more other functions. A function may also be initiated before the completion of another function.

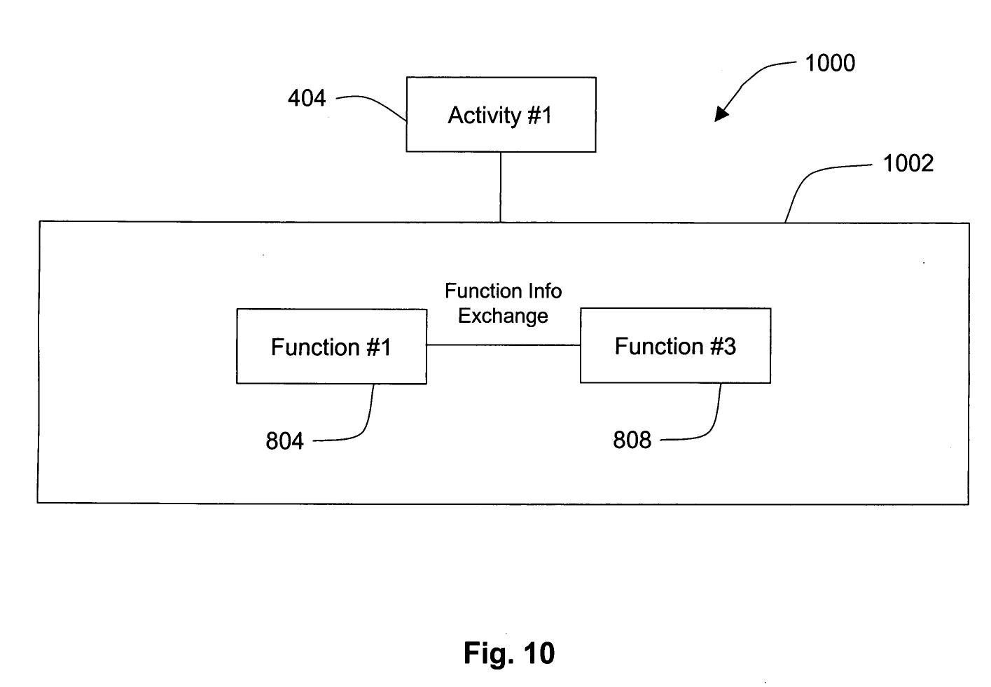

FIG. 10 illustrates a block diagram 1000 of another potential function sequence 1002 for the first activity 404. The first function 804 exchanges function information with the third function 808. The second function 806 is not involved in this other potential function sequence 1002. In the example provided above, the first function 804 of generating the digital signal can occur first. The third function 808 of storing the digital signal can occur second. The digital signal is not encrypted according to the second function 806 in this other potential function sequence 1002.

Subsequently, the first function 804 exchanges function information with third function 808. In the example provided above, the transmitter is assembled by first providing the communication mechanism of the second function and second by providing the circuit board of the first function. The storage medium of the third function can then be subsequently provided for after providing the circuit board of the first function.

One skilled in the art will recognize that complex systems will have a large order of magnitude of functions an function sequences. The examples illustrated herein are provided in order to explain distinctions between different activity sequences, function sequences, etc. The distinctions can be applied on a larger order of magnitude.

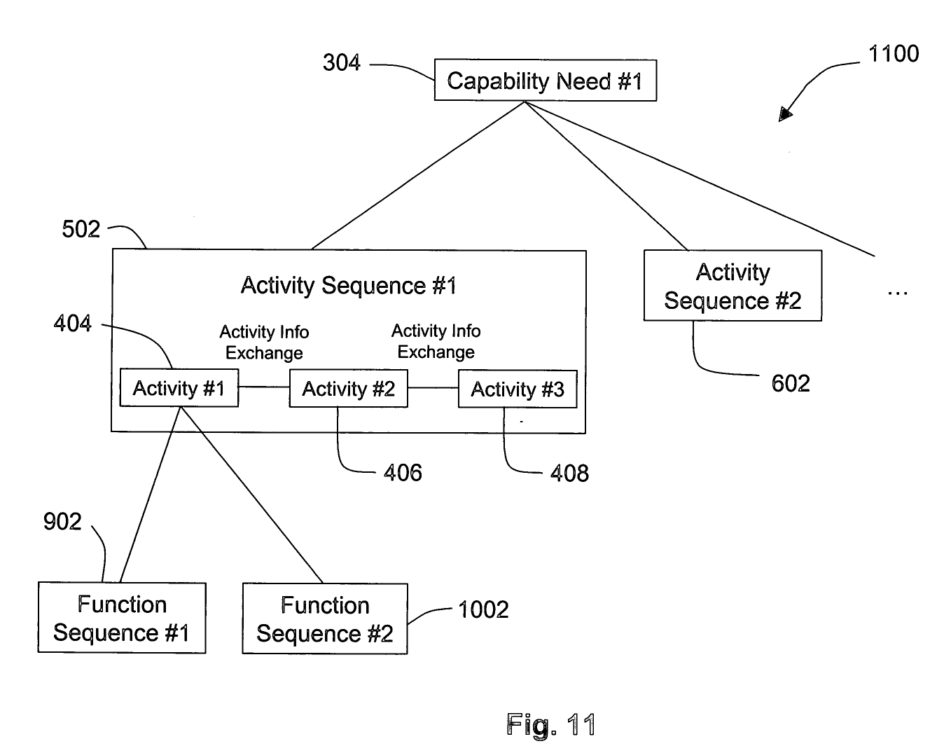

FIG. 11 illustrates the block diagram 700 of FIG. 7 with an expanded illustration of the first activity sequence 502. Accordingly, the first activity sequence 502 includes the first activity 404 exchanging activity information with the second activity 406, and the second activity 406 subsequently exchanging activity information with the third activity 408. The first activity includes the first function sequence 902 (FIG. 9) and the second function sequence 1002 (FIG. 10).

The second activity 406 and the third activity 408 will also have function sequences, which, for simplicity, are not illustrated. Further, the second activity sequence 602 will have activities which each have function sequences that are also not illustrated for simplicity.

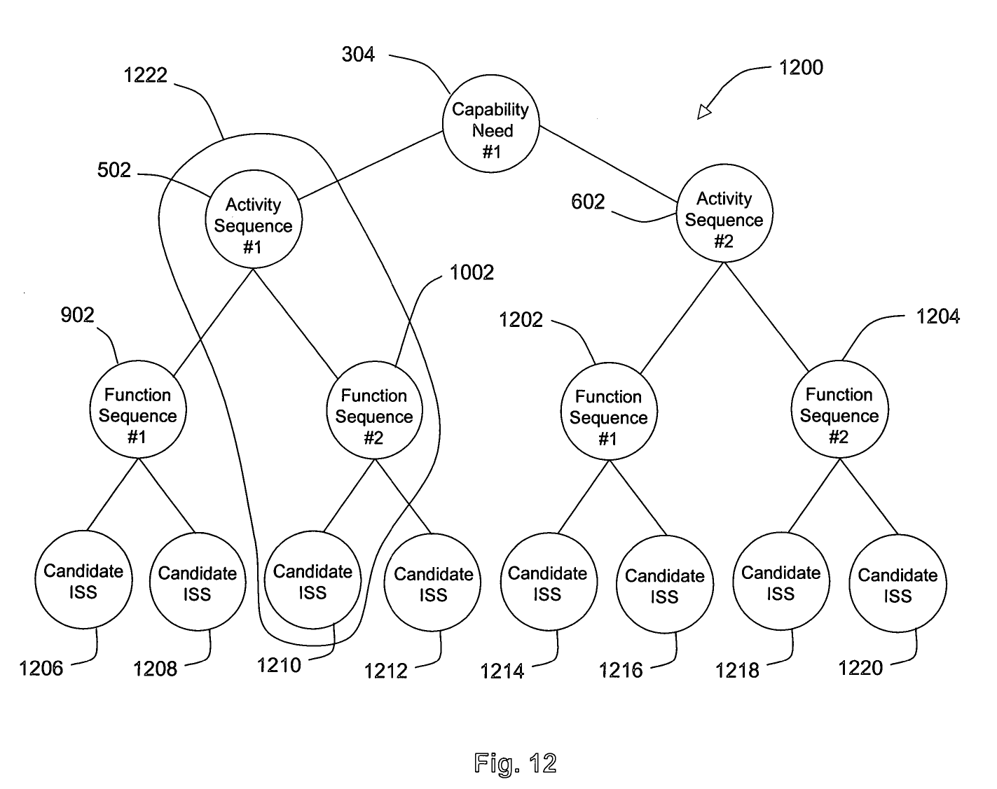

FIG. 12 illustrates a block diagram 1200 for candidate integrated solution sets. A number of candidate integrated solution sets can be generated for each capability that the customer 302 would like to have. However, the customer 302 would like to find the optimal integrated solution set from these candidate integrated solution sets.

For each capability, such as the first capability need 304, an analysis is performed to determine the optimal integrated solution set. For example, the first capability need 304 has potential activity sequences such as the first activity sequence 502 and the second activity sequence 602. The first activity sequence 502 and the second activity sequence 602 are each decomposed into function sequences. For example, the first activity sequence 502 is decomposed into the first function sequence 902 (FIG. 9) and the second function sequence 1002 (FIG. 10). Further, the second activity sequence 602 is decomposed into a first function sequence 1202 and a second function sequence 1204.

A candidate integrated solution set is generated for each function sequence. For instance, a candidate integrated solution set 1206 is generated for the first function sequence 902 for the first activity sequence 502 for the first capability need 304. Further, a candidate integrated solution set 1208 is generated for the first function sequence 902 for the first activity sequence 502 for the first capability need 304. In addition, a candidate integrated solution set 1210 is generated for the second function sequence 1002 for the first activity sequence 502 for the first capability need 304. Further, a candidate integrated solution set 1212 is generated for the second function sequence 1002 for the first activity sequence 502 for the first capability need 304. In addition, a candidate integrated solution set 1214 is generated for the first function sequence 1202 for the second activity sequence 602 for the first capability need 304. Further, a candidate integrated solution set 1216 is generated for the first function sequence 1202 for the second activity sequence 602 for the first capability need 304. In addition, a candidate integrated solution set 1218 is generated for the second function sequence 1204 for the second activity sequence 602 for the first capability need 304. Further, a candidate integrated solution set 1220 is generated for the second function sequence 1204 for the second activity sequence 602 for the first capability need 304.

In one embodiment, an optimal integrated solution set is found for each activity sequence. For instance, a first optimal integrated solution set for the first activity sequence 502 is selected from the candidate integrated solution set 1206, the candidate integrated solution set 1208, the candidate integrated solution set 1210, and the candidate integrated solution set 1212. A second optimal integrated solution set for the second activity sequence 602 is selected from the candidate integrated solution set 1214, the candidate integrated solution set 1216, the candidate integrated solution set 1218, and the candidate integrated solution set 1220. The optimal integrated solution set for the first capability need 304 can then be selected form the first optimal integrated solution set and the second optimal integrated solution set. In another embodiment, the optimal integrated solution set is selected from all of the candidate integrated solution sets without finding an optimal integrated solution set for each activity sequence.

Irrespective of the process for finding the optimal integrated solution set, a candidate integrated solution set for a function sequence is selected as the optimal integrated solution set. For instance, an optimal selection 1222 illustrates the candidate integrated solution set 1210 as being selected for the optimal integrated solution set. The candidate integrated solution set 1210 provides the second function sequence 1002, which can be found in the first activity sequence 502.

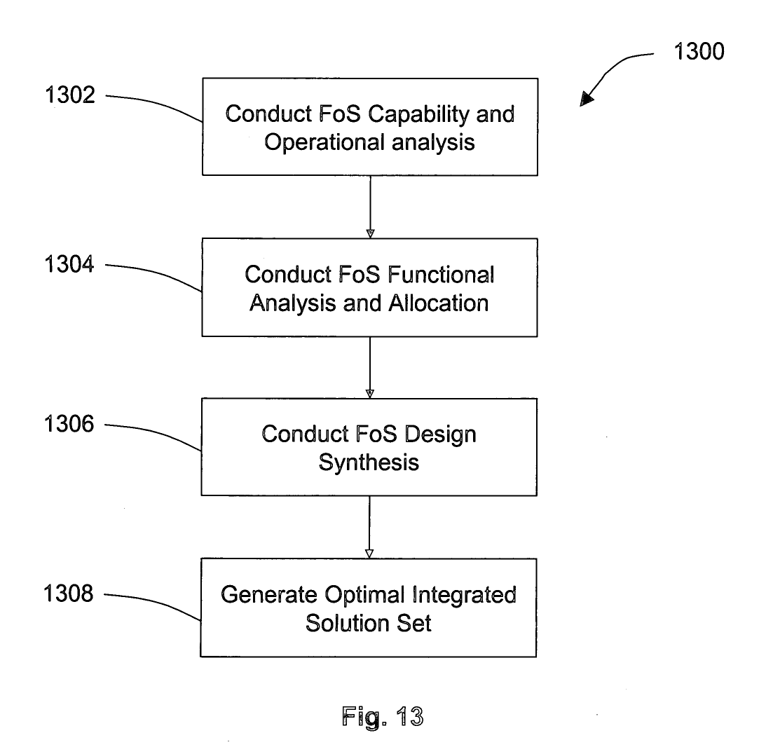

FIG. 13 illustrates a FoSSE™ method 1300 of enhancing capabilities. For example, the FoSSE™ method 1300 performs analysis on capabilities, such as the first capability need 304, and the sub-components of the capabilities to find the optimal integrated solution for each capability. The FoSSE™ method 1300 deals with the complexity inherent in developing and acquiring interoperable FoSs. The FoSSE™ method 1300 is focused on achieving capabilities through both the individual operation and the collective interoperation of systems and processes. A structured, measurable, engineering-based process is provided for first capturing the wide array of capability needs in an environment and then aligning both existing and emerging resources with these needs. The FoSSE™ method 1300 produces rigorous, capability-based results that form the basis for fact-based FoS investment decisions. The FoSSE™ method 1300 can unravel FoS complexity to support achievement of the dramatic capability improvements that are possible through the integration of systems and processes into interoperable FoSs. The FoSSE™ method 1300 can also address the complexity of FoS environments and creating actionable results necessary for transforming available and emerging technology into integrated FoSs to significantly increase organizational capability.

At a first process block 1302, the FoSSE™ method 1300 conducts FoS capability and operational analysis that generates a set of operationally decomposed capability needs. In one embodiment, each of the operationally decomposed capability needs in the set of operationally decomposed capability needs includes an activity sequence such as the first activity sequence 502 (FIG. 5) or the second activity sequence 602 (FIG. 6). In one embodiment, each of the activity sequences includes one or more activities and activity information exchanges between the activities. For instance, the first activity sequence 502 (FIG. 5) can be decomposed into the first activity 404, the second activity 406, and the third activity 408.

Further, at a process block 1304, the FoSSE™ method 1300 conducts FoS functional analysis and allocation on the set of operationally decomposed capability needs to determine a set of deficiencies. In one embodiment, each of the activities can be decomposed into a function sequence so that an analysis can be performed on the functions associated with an activity in an activity sequence. In one embodiment, each of the function sequences includes one or more functions and function information exchanged between the functions. For instance, the first activity 404 can be decomposed into a first function sequence 902 and a second function sequence 1002.

In addition, at a process block 1306, the FoSSE™ method 1300 conducts FoS design synthesis on the set of operationally decomposed capability needs, a set of existing solutions, and a set of emerging solutions to identify and describe an optimal integrated solution set of existing solutions and emerging solutions to satisfy the set of operationally decomposed capability needs. Finally, at a process block 1308, the FoSSE™ method 1300 generates the optimal integrated solution set of existing solutions and emerging solutions from the family of systems design synthesis.

The FoSSE™ method 1300 is the primary analytical engine of the CP process. The FoSSE™ method 1300 employs information from customer experts and existing architecture products to perform rigorous, systems engineering-like trades analysis to evaluate materiel and non-materiel FoS alternatives.

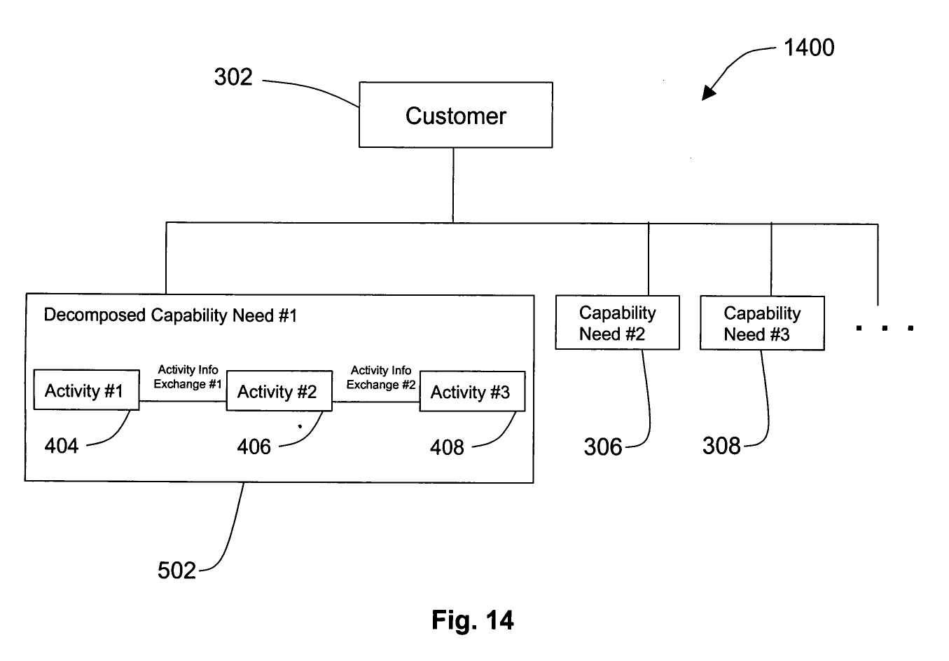

FIG. 14 illustrates a block diagram 1400 for the family of systems capability and operational analysis. Each of the capabilities desired by the customer 302 is decomposed into at least one activity sequence. For example, as illustrated in FIG. 14, the first capability need 304 is decomposed into the activity sequence 502. The first activity 404, the second activity 406, the third activity 408, and the activity information exchanges between these activities can now be analyzed. Other activity sequences for the first capability need 304 can also be analyzed, but are not shown here for simplicity. Further, each of other capabilities, such as the second capability 306 and the third capability 308, can also be expanded for analysis, but are not shown here for simplicity.

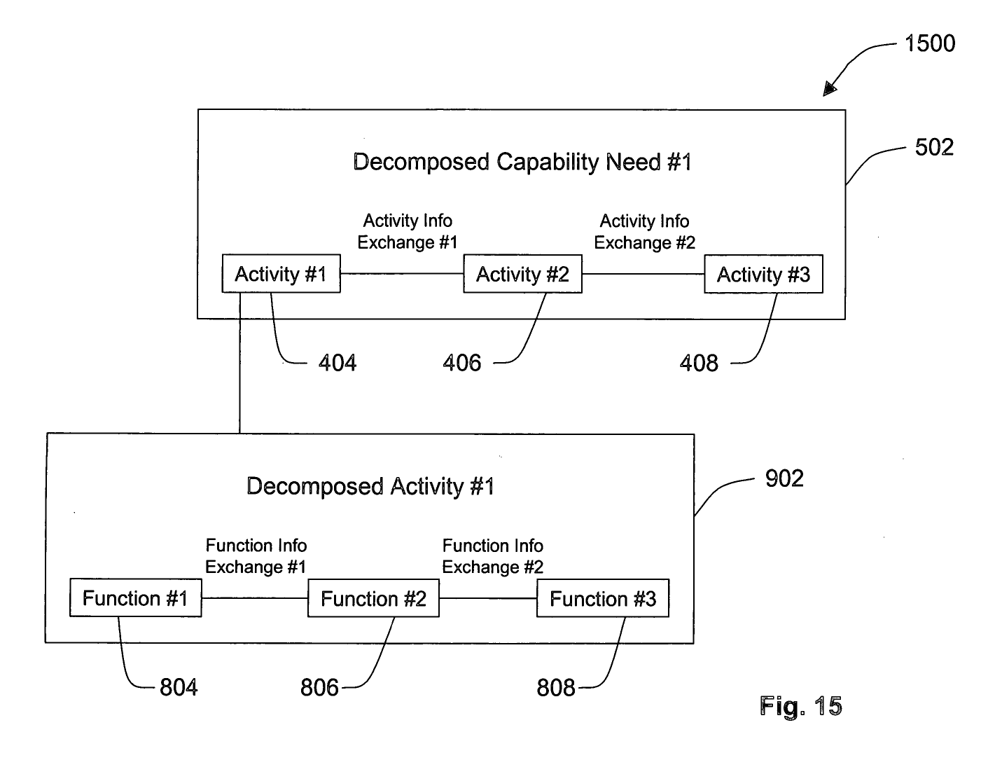

FIG. 15 illustrates a block diagram 1500 for the family of systems functional analysis and allocation in which an activity is decomposed into at least one function sequence. After the capability needs desired by the customer 302 are decomposed into activity sequences, each of the activities in the activity sequences can be decomposed into one or more function sequences in the family of systems functional analysis and allocation. For example, each activity in the activity sequence 502 is decomposed into potential function sequences. For simplicity, only the function sequence 902 is illustrated. However, a complex system will likely have many potential function sequences for an activity in the activity sequence 502. The function sequence 902 includes the first function 804, the second function 806, and the third function 808, and any function information exchanges between the functions.

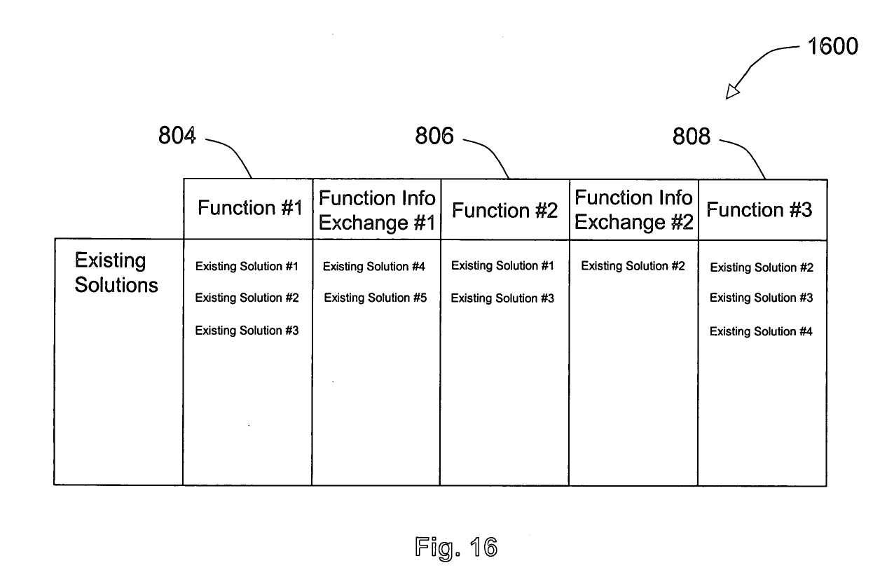

FIG. 16 illustrates a matrix 1600 for the family of systems functional analysis and allocation in which a determination is made for each function as to what existing solutions can provide the function. The customer 302 may have existing solutions that can effectively provide a function. These solutions are taken under consideration for the determining the optimal integrated solution set because the customer 302 may incur less expense than adopting a new solution. However, a new solution may ultimately be less expensive and/or more productive. The existing solution may be a legacy or a manual solution. The organization of the results from the analysis does not necessarily have to be provided in the form of a matrix, but is done so here to illustrate one form of the presentation of the results from the analysis.

Utilizing the example illustrated in FIG. 15 here, a determination is made as to what existing solutions could provide each of the functions and function information exchanges in the first function sequence 902. For instance, for the first function 804, any one of the first existing solution, second existing solution, or third existing solution can provide the first function 804. Further, either the fourth existing solution or the fifth existing solution can provide the first function information exchange. In addition, either the first existing solution or the third existing solution can provide the second function 806. Further, the second existing solution is the only existing solution that can provide the second function information exchange. Finally, any one of the second existing solution, third existing solution, or fourth existing solution can provide the third function. The actual existing solution that is selected is not chosen at this point in the FoSSE™ method 300 because consideration has to be given to what mixture of existing solutions and new solutions will provided the optimal integrated solution set.

In determining whether existing solutions can provide the functions, a determination is made as to whether there are any deficiencies in the functions or function information exchanges. Those deficiencies are identified during the process so that the deficiencies may be corrected.

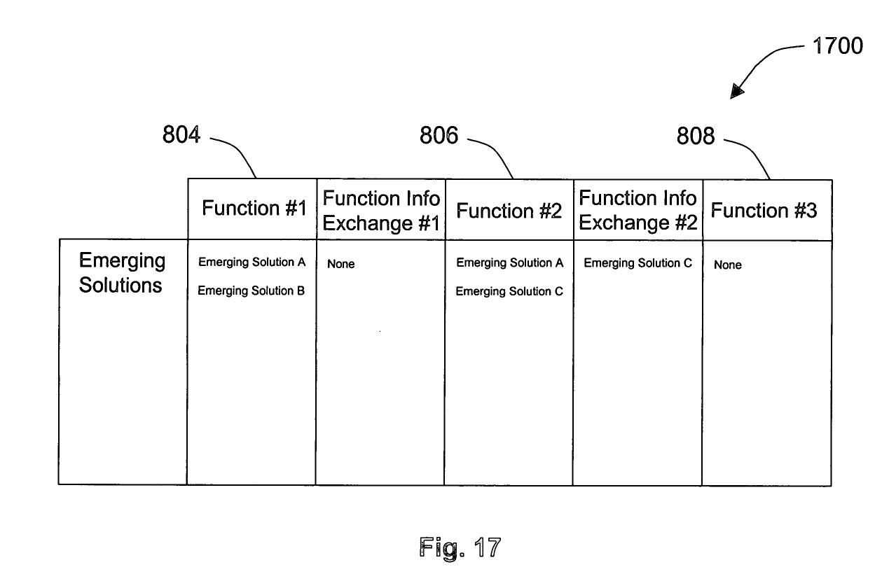

FIG. 17 illustrates a matrix 1700 that is utilized in the family of systems design synthesis. While each function and function information exchange was analyzed in FIG. 16 to determine what existing solutions would be sufficient for each function and function information exchange, the family of systems design synthesis initially determines what emerging solutions would satisfy each function and function information exchange. For example, the emerging solutions can be new solutions that the customer 302 may not have expended resources to implement yet. The matrix 1700 is just one example of how the data can be visually represented.

For the first function 804, either Emerging Solution A or Emerging Solution B can provide the first function 804. None of the Emerging Solutions can provide the first function information exchange. Therefore, as illustrated in FIG. 16, either the fourth existing solution or the fifth existing solution will be needed to provide the first function information exchange. Either Emerging Solution A or Emerging Solution C can provide the second function 806. Further, only Emerging Solution C can provide the second function information exchange. Finally, none of the emerging solutions can provide the third function 808. Therefore, as illustrated in FIG. 16, any one of the second existing solution, the third existing solution, or the fourth existing solution can provide the third function 808.

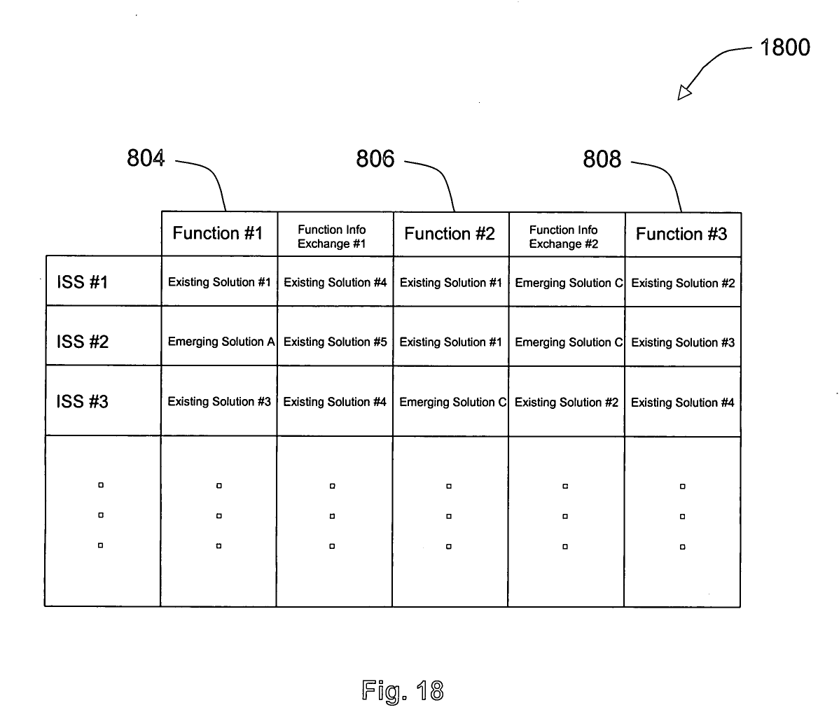

FIG. 18 illustrates an Integrated Solution Set matrix 1800. Utilizing the assessment made in FIGS. 16 and 17 for which existing and emerging solutions satisfy each of the functions and function information exchanges, the family of systems design synthesis composes a plurality of integrated solutions sets. Each of the integrated solutions sets includes either an existing solution or an emerging solution for each function. In one embodiment, a combination of solutions may be provided for a function in an integrated solution set, i.e., more than one existing solution, more than one emerging solution, or a combination of at least one existing solution and at least one emerging solution. For simplicity, the figures illustrate only one solution, existing or emerging, per function in the integrated solution set.

The Integrated Solution Set matrix 1800 includes a set of candidate ISSs as illustrated in FIG. 12. The candidate ISSs are determined using a search algorithm to search all the possible sets that have an existing solution or an emerging solution for each function. The candidate ISSs can be generated by combining the existing solutions for each function illustrated in FIG. 16 with the emerging solutions for each function illustrated in FIG. 17. For instance, ISS #1 includes the first existing solution for the first function 804, the fourth existing solution for the first function information exchange, the first existing solution for the second function 806, the emerging solution C for the second function information exchange, and the second existing solution for the third function 808. Further, ISS #2 includes the emerging solution A for the first function 804, the fifth existing solution for the first function information exchange, the first existing solution for the second function 806, the emerging solution C for the second function information exchange, and the third existing solution for the third function 808. In addition, ISS #3 includes the third existing solution for the first function 804, the fourth existing solution for the first function information exchange, the emerging solution C for the second function 806, the second existing solution for the second function information exchange, and the fourth existing solution for the third function 808. For simplicity, the complete list of ISSs is not illustrated. Further, the matrix is only one form of visual presentation for the candidate ISSs. Other forms of visual presentation such as lists, graphs, etc. can be utilized.

Once the candidate ISSs are generated, the family of systems design synthesis performs a filtering process to determine the optimal ISS from the candidate ISSS. As illustrated in FIG. 12, the optimal ISS is chosen from the candidate ISSs. In one embodiment, the filtering process involves a first order analysis and a second order analysis. CP can involve a very large number of ISSs. Accordingly, the first order analysis helps filter a larger number candidate ISSs out so that a detailed second order analysis can be performed to determine the optimal ISS. Therefore, the first order analysis produces a subset of the candidate ISSs. The second order analysis is performed on the subset of the candidate ISSs to determine the optimal ISS.

The first order analysis includes a performance determination. A plurality of functionality thresholds are established. In other words, for each function in an activity within an activity sequence, a solution must meet an established functionality threshold. For instance, in the first activity 404 (FIG. 15), a first functionality threshold is established for the first function 804, a second functionality threshold is established for the second function 806, and a third functionality threshold is established for the third function 808. Referring to ISS #1 in FIG. 18, the first existing solution is provided for the first function 804 and therefore must meet the first functionality threshold established for the first function 804. Further, the first existing solution is provided for the second function 806 and therefore must meet the second functionality threshold established for the first function 806. In addition, the second existing solution is provided for the third function 808 and therefore must meet the third functionality threshold established for the first function 808. If any one of the first functionality threshold, second functionality threshold, or third functionality threshold are not met, then ISS #1 is filtered out and is no longer a candidate ISS for possibly being selected as the optimal ISS. In one embodiment, multiple solutions can be provided for a particular function in an ISS. If any one of those functions meet the functionality threshold, then the functionality threshold is determined to be met even though another solution for that same function does not meet the functionality threshold. In an alternative embodiment, an ISS is filtered out if one solution does not meet the functionality threshold, regardless of another solution meeting the functionality threshold for the same function.

After the ISSs are filtered out according to the functionality thresholds, a composite functionality score analysis is performed on the remaining ISSs. For each ISS, a calculation is performed to determine a plurality of function scores for the ISS. In other words, the ISS receives a score for each function. For instance, the score can be on a scale of 0 to 10. Assuming that ISS #2 was not filtered out according to functionality thresholds and is retained for the composite functionality score analysis, ISS #2 receives a functionality score for each function. Therefore, ISS #2 receives a functionality score for how well the emerging solution A performs the first function 804. In an alternative embodiment, if ISS #2 has multiple solutions that provide the first function 804, then ISS #2 receives a functionality score according to how the solution that performs the first function 804 the best. There may be a tie for the solution that performs the first function 804 the best, and the score for the tie would still be the highest and therefore the functionality score that ISS #2 would receive for the first function 804. Accordingly, ISS #2 receives a functionality score for how well the first existing solution performs the second function 806. Further, ISS #2 also receives a functionality score for how well the third existing solution performs the third function 808. A calculation is then performed on the plurality of functionality scores for ISS #2, e.g., the first functionality score of ISS #2 for the first function 804, the second functionality score of ISS #2 for the second function 806, and the third functionality score of ISS #2 for the third function 808. The calculation results in a composite functionality score for ISS #2. In one embodiment, the calculation is a sum of the scores. In another embodiment, the calculation is a ration of the sum of the scores to a sum of the maximum scores.

As a result of the composite functionality score analysis, the remaining candidate ISSs are all assigned a composite functionality score. The candidate ISSs can now be filtered again by determining which ISSs do not have a composite functionality score that is above a composite functionality score threshold. The remaining candidate ISSs are then retained for further analysis.

A composite interoperability score analysis is then performed on the remaining candidate ISSs. For each ISS, a calculation is performed to determine a plurality of interoperability scores for the ISS. In other words, the ISS receives a score for each function information exchange. The candidate ISSs that were previously selected were chosen because of how well solutions performed individual functions. However, it is possible that a first solution may perform a first function well, and a second solution may perform a second function well, but the two solutions may be incompatible with one another. For instance, the first solution may be a piece of software that only performs on one computing platform while the second solution may be a different piece of software that only performs a different computing platform. In this instance, it may be more optimal to have an ISS that has two pieces of software of a slightly lesser quality but that are compatible with one another.

Assuming that ISS #2 is not filtered out, a first interoperability score is determined for the first function information exchange, and a second interoperability score is determined for the second function information exchange. For instance, the score for the first function information exchange is determined according to how well the emerging solution A interoperates with the first existing solution. The fifth existing solution helps facilitate the interoperation of the emerging solution A and the first existing solution. If multiple solutions are provided for a function, then the solution with the best functionality score is selected for purposes of the interoperability analysis. For example if there are multiple solutions in the ISS #2 to provide the first function, the solution with the best functionality score for the first function 804 is selected for the interoperability score analysis. If there is a tie, then multiple solutions for the first function 804 are analyzed for interoperability with a solution that satisfies the second function 806. If there are also multiple solutions in the ISS #2 to provide the second function, the solution with the best functionality score for the second function 806 is selected for the interoperability score analysis. If there is a tie, then multiple solutions for the second function 806 are analyzed for interoperability with a solution that satisfies the first function 804. If there is a tie for multiple solutions best satisfying the first function 804 and a tie for multiple solutions best satisfying the second function 806, then the interoperability analysis would involve each of the tied solutions of the first function 804 interoperating with each of the tied solutions of the second function 806. In addition, the score for the second function information exchange is determined according to how well the first existing solution interoperates with the third existing solution. The emerging solution C helps facilitate the interoperation between the first existing solution and the third existing solution.

A calculation is then performed on the plurality of interoperability scores to determine a composite interoperability score for each ISS. In one embodiment, the sum is taken of the interoperability scores. In another embodiment a ratio is taken of the sum of the interoperability scores to the sum of the maximum possible scores for the interoperability scores. Once each candidate ISS is assigned a composite interoperability score, the candidate ISSs can once again be filtered to ensure that only the ISSs that are above a composite interoperability score threshold are retained for further analysis.

In one embodiment, the remaining ISSs are retained for a cost analysis. Each ISS is analyzed to determine a cost for the ISS.

In one embodiment, the remaining ISSs are retained for a cost-benefit optimization analysis. Each of the remaining candidate ISSs is evaluated to determine if the composite functionality score falls within a range of composite functionality scores, the composite interoperability score falls within a range of composite interoperability scores, and the cost falls within a range of costs. If the ISS has scores that fall within all the requisite ranges, then the ISS is kept for further analysis. If the ISS has a score that does not fall within one of the requisite ranges, then the ISS is filtered out. In another embodiment, the requisite ranges can be established to include ranges for functionality, interoperability, or cost, or any combination or sub-combination thereof. For instance, ranges for functionality and interoperability may be established as the requisite criteria without cost.

In another embodiment, the remaining ISSs are retained for a risk analysis. Each ISS is analyzed to determine a risk for the ISS.

In one embodiment, the remaining ISSs are retained for a risk-benefit optimization analysis. Each of the remaining candidate ISSs is evaluated to determine if the composite functionality score falls within a range of composite functionality scores, the composite interoperability score falls within a range of composite interoperability scores, and the risk falls within a risk range. If the ISS has scores that fall within all the requisite ranges, then the ISS is kept for further analysis. If the ISS has a score that does not fall within one of the requisite ranges, then the ISS is filtered out. In another embodiment, the requisite ranges can be established to include ranges for functionality, interoperability, or risk, or any combination or sub-combination thereof. For instance, ranges for functionality and interoperability may be established as the requisite criteria without risk.

In one embodiment, the remaining ISSs are retained for a cost analysis and a risk analysis. Each ISS is analyzed to determine a cost for the ISS. Further, each ISS is analyzed to determine a risk for the ISS

In one embodiment, the remaining ISSs are retained for a cost-risk-benefit optimization analysis. Each of the remaining candidate ISSs is evaluated to determine if the composite functionality score falls within a range of composite functionality scores, the composite interoperability score falls within a range of composite interoperability scores, the cost falls within a range of costs, and the range falls within a risk range. If the ISS has scores that fall within all the requisite ranges, then the ISS is kept for further analysis. If the ISS has a score that does not fall within one of the requisite ranges, then the ISS is filtered out. In another embodiment, the requisite ranges can be established to include ranges for functionality, interoperability, cost, risk, or any combination or sub-combination thereof. For instance, ranges for functionality, interoperability, and cost may be established as the requisite criteria without risk.

In another embodiment, cost and risk are not evaluated for each ISS. After the candidate ISSs that are above the composite interoperability score threshold are retained, an interoperability optimization analysis is performed to determine if the ISS has a composite interoperability score that falls within a range of composite interoperability scores.

In yet another embodiment, interoperability, cost, and risk are not evaluated for each ISS. After the candidate ISSs that are above the composite functionality score threshold are retained, a functionality optimization analysis is performed to determine if the ISS has a composite functionality score that falls within a range of composite functionality scores.

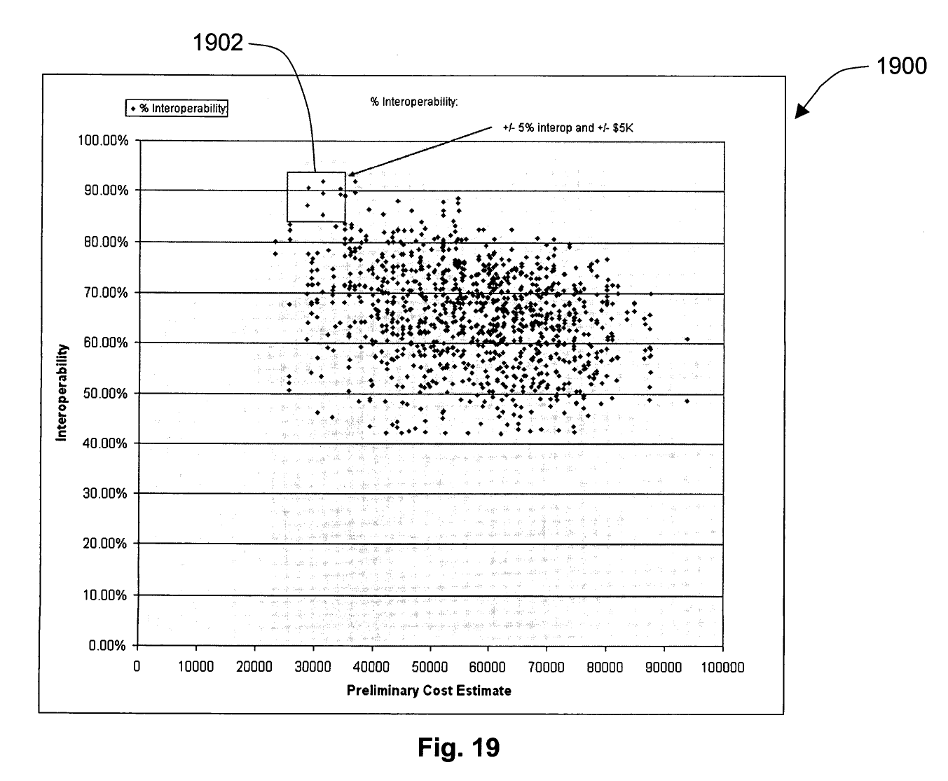

FIG. 19 illustrates a plot 1900 which can be utilized to determine the subset of candidate ISSs. A visual representation, such as a plot or matrix, can be used help determine the subset of candidate ISSs. The plot 1900 illustrates the use of composite interoperability scores and costs to determine a region 1902 that contains the subset of the candidate ISSs. The region 1902 illustrates graphically a grouping of ISSs that have the best combination of interoperability and cost.

As a result of one of the various optimization methodologies described, a subset of candidate ISSs is determined. The subset of candidate ISSs is then provided a second order optimization analysis to determine the optimal ISS. Each of the ISSs in the subset are evaluated to determine whether the ISS satisfies one or more ranges of second order criteria. The one or more ranges of second order criteria include a combination or any sub-combination of a level of performance that is measured according to one or more capability metrics, a second order cost, a second order risk, and an implementation schedule. The level of performance is determined by utilizing a simulation on each ISS in the subset of the plurality of integrated solutions sets to estimate the one or more capability metrics for each ISS in the subset of the plurality of ISS performing the function sequences and activity sequences in the operationally decomposed capability needs. After the requisite ranges are determined and the second order optimization analysis is performed on the ISSs in the subset according to the requisite ranges, the optimal ISS is determined.

In one embodiment, as discussed with respect to FIG. 12, the optimal ISS may be determined for each potential activity sequence. The optimal ISS can then be selected according to the preferred activity sequence. In another embodiment, the optimal ISS is simply chosen by evaluating all the candidate ISSs, from all activity sequences, as a whole.

Variations to the methodologies provided above can be provided for. For instance, different criteria that would be helpful to the customer 302 in determining an optimal integrated solution set can be used with either the first order or second order level of analysis. In addition various other methodologies can be utilized in conjunction with the methodologies described above.

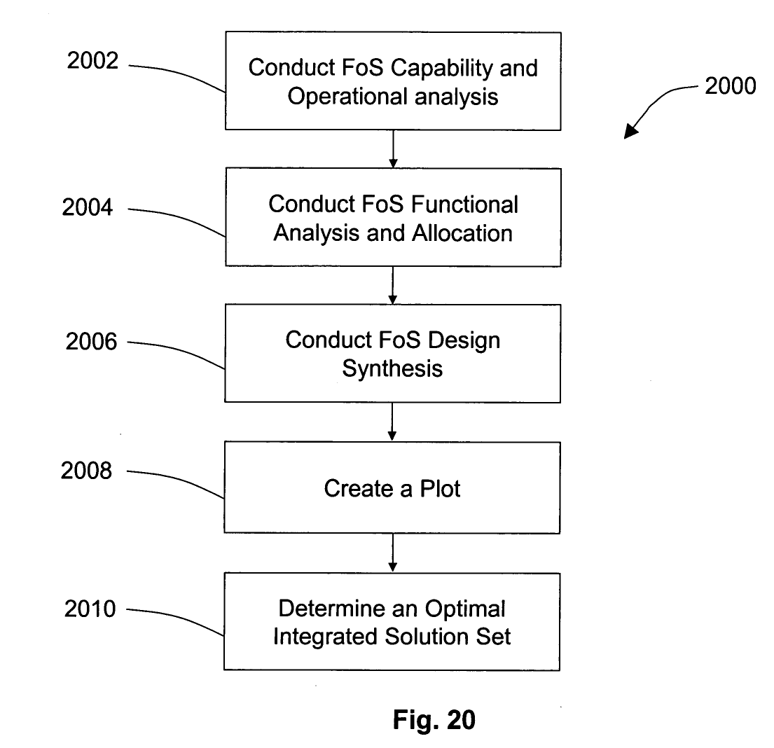

FIG. 20 illustrates a process 2000 for enhancing capabilities. At a process block 2002, a family of systems capability and operational analysis is conducted to generate a set of operationally decomposed capability needs. Further, at a process block 2004, a family of systems functional analysis and allocation is conducted on the set of operationally decomposed capability needs to determine a set of deficiencies. In addition, at a process block 2006, a family of systems design synthesis is conducted on the set of operationally decomposed capability needs, a set of existing solutions, and a set of emerging solutions. Further, at a process block 2008, a plot is created from the family of systems design synthesis that illustrates one or more desirable integrated solution sets of existing solutions and emerging solutions. Finally, at a process block 2010, an optimal integrated solution set of existing solutions and emerging solutions is determined, from the plot, to satisfy the set of operationally decomposed capability needs.

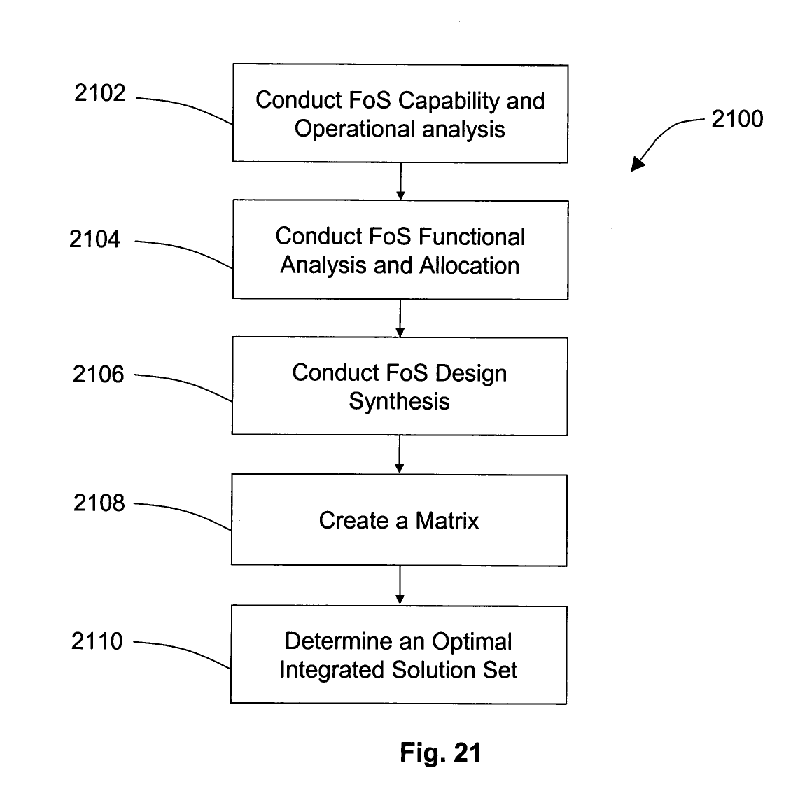

FIG. 21 illustrates a process 2100 for enhancing capabilities. At a process block 2102, a family of systems capability and operational analysis is conducted to generate a set of operationally decomposed capability needs. Further, at a process block 2104, a family of systems functional analysis and allocation is conducted on the set of operationally decomposed capability needs to determine a set of deficiencies. In addition, at a process block 2106, a family of systems design synthesis is conducted on the set of operationally decomposed capability needs, a set of existing solutions, and a set of emerging solutions. Further, at a process block 2108, a matrix is created from the family of systems design synthesis that illustrates one or more desirable integrated solution sets of existing solutions and emerging solutions. Finally, at a process block 2110, an optimal integrated solution set of existing solutions and emerging solutions is determined, from the matrix, to satisfy the set of operationally decomposed capability needs.

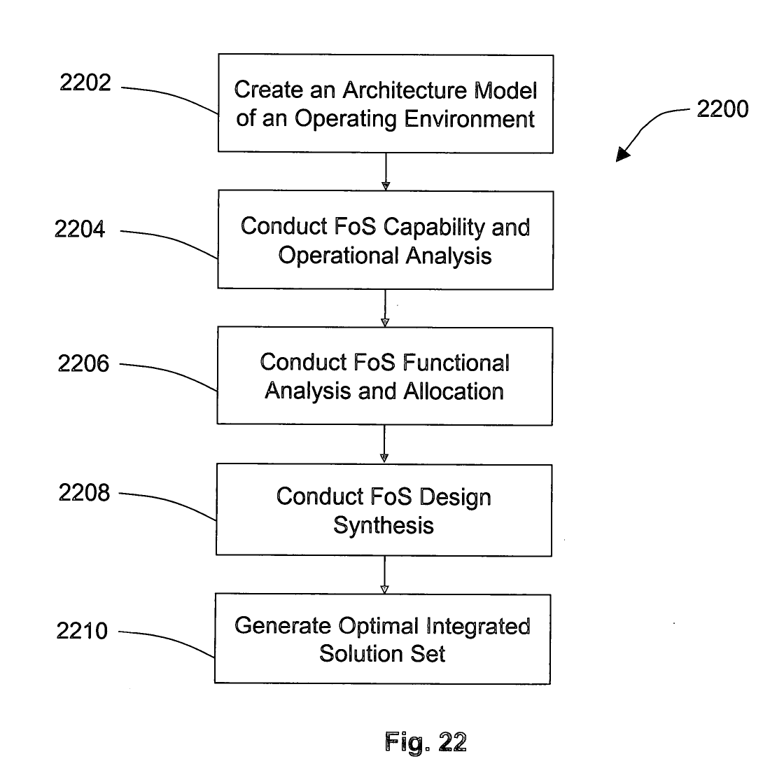

FIG. 22 illustrates a process 2200 for enhancing capabilities. At a process block 2202, an architecture model of an operating environment is created. Further, at a process block 2204, a family of systems capability and operational analysis is conducted on data from the architecture model using simulation and analysis to generate a set of operationally decomposed capability needs. User requirements, desired capabilities, and system upgrades maintenance can be provided to the family of systems capability and operational analysis. In addition, at a process block 2106, a family of systems functional analysis and allocation is conducted on the set of operationally decomposed capability needs and data from the architecture model using simulation and analysis to determine a set of deficiencies. Deficiencies can be determined as a result of the family of systems functional analysis and allocation. Further, at a process block 2108, a family of systems design synthesis is conducted on the set of operationally decomposed capability needs, a set of existing solutions, a set of emerging solutions, and data from the architecture model using simulation and analysis to identify and describe an optimal integrated solution set of existing solutions and emerging solutions to satisfy the set of operationally decomposed capability needs. Emerging solutions can be provided to the family of systems design synthesis. Further, at a process block 2110, a matrix is created from the family of design synthesis that illustrates one or more desirable integrated solution sets of existing solutions and emerging solutions. Finally, at a process block 2110, an optimal integrated solution set of existing solutions and emerging solutions is generated from the family of systems design synthesis.

In another embodiment, the first order analysis is performed without the second order analysis. The customer 302 may wish to receive the subset of the candidate ISSs to see a filtered number of candidate ISSs. In other words, the first order analysis may be sufficient for the customer because the first order analysis can take a very large number of ISSs, e.g. an almost infinite number of ISSs, and produce a finite and relatively small number of ISSs that can be realistically reviewed by the customer 302. The customer 302 may not want to utilize the FoSSE™ second order analysis in order to determine the optimal ISS, but rather select the optimal ISS from the filtered number of candidate ISSs generated from the FoSSE™ first order analysis.

In yet another embodiment, the second order analysis is performed without the first order analysis. The optimal ISS is determined from the candidate ISSs without determining a subset of ISSs. For instance, if the set of possible candidate ISSs is not of an order of magnitude of an almost infinite size, a manageable number of candidate ISSs can be provided to the second order analysis without first determining a subset.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of enhancing capabilities, comprising:
conducting family of systems capability and operational analysis that generates a set of operationally decomposed capability needs;
conducting family of systems functional analysis and allocation on the set of operationally decomposed capability needs to determine a set of deficiencies;
conducting family of systems design synthesis on the set of operationally decomposed capability needs, a set of existing solutions, and a set of emerging solutions to identify and describe an optimal integrated solution set of existing solutions and emerging solutions to satisfy the set of operationally decomposed capability needs; and
generating the optimal integrated solution set of existing solutions and emerging solutions from the family of systems design synthesis.

2. The method of claim 1, wherein each of the operationally decomposed capability needs in the set of operationally decomposed capability needs includes an activity sequence.

3. The method of claim 2, wherein the activity sequence includes a plurality of activities.

4. The method of claim 3, wherein the activity sequence includes information that is exchanged between activities in the plurality of activities.

5. The method of claim 3, wherein each of the activities includes a function sequence.

6. The method of claim 5, wherein the function sequence includes a plurality of functions.

7. The method of claim 6, wherein the function sequence includes information that is exchanged between functions in the plurality of functions.

8. The method of claim 6, wherein the family of systems functional analysis and allocation includes an assessment of each of the functions to determine which, if any, of the existing solutions can provide the function.

9. The method of claim 8, wherein the family of systems functional analysis and allocation includes an assessment of interoperability for each of the existing solutions with the remaining existing solutions in the set of existing solutions.

10. The method of claim 8, wherein for each of the functions the family of systems design synthesis determines which, if any, of the emerging solutions can provide the function.

11. The method of claim 8, wherein the family of systems design synthesis includes an assessment of interoperability of each of the emerging solutions with the remaining solutions in the set of emerging solutions and with the existing solutions in the set of existing solutions.

12. The method of claim 11, further comprising composing a plurality of integrated solution sets, wherein each of the plurality of integrated solutions sets includes, for each function, one of the emerging solutions or one of the existing solutions that can each respectively provide the function.

13. The method of claim 12, wherein the optimal integrated solutions set of existing solutions and emerging solutions is selected from the plurality of integrated solutions sets based on a set of criteria.

14. The method of claim 13, wherein the criteria is based on a level of performance that is measured according to a capability metric.

15. The method of claim 13, wherein the criteria is based on a cost.

16. The method of claim 13, wherein the criteria is based on a risk assessment.

17. The method of claim 13, wherein the criteria is based on an implementation schedule.

18. The method of claim 11, further comprising composing a plurality of integrated solution sets, wherein each of the plurality of integrated solutions sets includes, for each function, at least one of the emerging solutions or at least one of the existing solutions that can each respectively provide the function.

19. The method of claim 18, wherein the optimal integrated solutions set of existing solutions and emerging solutions is selected from the plurality of integrated solutions sets based on a set of criteria.

20. The method of claim 19, wherein the criteria is based on a level of performance that is measured according to a capability metric.

21. The method of claim 19, wherein the criteria is based on a cost.

22. The method of claim 19, wherein the criteria is based on a risk assessment.

23. The method of claim 19, wherein the criteria is based on an implementation schedule.

24. The method of claim 11, further comprising composing a plurality of integrated solution sets, wherein each of the plurality of integrated solutions sets includes, for each function, at least one of the emerging solutions, at least one of the existing solutions, or at least one of the emerging solutions and at least one of the existing solutions that can each respectively provide the function.

25. The method of claim 24, wherein the optimal integrated solutions set of existing solutions and emerging solutions is selected from the plurality of integrated solutions sets based on a set of criteria.

26. The method of claim 25, wherein the criteria is based on a level of performance that is measured according to a capability metric.

27. The method of claim 25, wherein the criteria is based on a cost.

28. The method of claim 25, wherein the criteria is based on a risk assessment.

29. The method of claim 25, wherein the criteria is based on an implementation schedule.

30. The method of claim 24, further comprising selecting a subset of the plurality of integrated solutions sets according to a first order analysis.

31. The method of claim 30, wherein the first order analysis includes a performance determination, for each integrated solution set in the plurality of integrated solutions sets, of whether each of a plurality of functionality thresholds is met by at least one solution in the integrated solution set in the plurality of integrated solution sets.

32. The method of claim 31, wherein the integrated solution set in the plurality of integrated solution sets is filtered out if each of the plurality of functionality thresholds is not met by at least one solution in the integrated solution set in the plurality of integrated solution sets.

33. The method of claim 31, wherein the integrated solution set in the plurality of integrated solution sets is retained for a composite functionality score analysis if each of the plurality of functionality thresholds is met by at least one solution in the integrated solution set in the plurality of integrated solution sets.

34. The method of claim 33, wherein the composite functionality score analysis includes a calculation of a plurality of function scores for the integrated solution set in the plurality of integrated solution sets that are retained for the composite functionality score analysis, wherein each of the function scores in the plurality of function scores is determined according to one or more solutions in the integrated solution set that best satisfy the function associated with the function score.

35. The method of claim 34, wherein the calculation of the plurality of function scores for the integrated solution set in the plurality of integrated solution sets is a sum of the plurality of function scores for the integrated solution set in the plurality of integrated solution sets.

36. The method of claim 34, wherein the calculation of the plurality of function scores for the integrated solution set in the plurality of integrated solution sets is a ratio of a sum of the plurality of function scores for the integrated solution set in the plurality of integrated solution sets to a sum of a plurality of maximum function scores.

37. The method of claim 34, wherein the integrated solution set in the plurality of integrated solution sets is retained for a composite interoperability score analysis if an outcome of the calculation of the plurality of function scores for the integrated solution set in the plurality of integrated solution sets is above a composite functionality score threshold.

38. The method of claim 37, wherein the composite interoperability score analysis is performed for each integrated solution set in the plurality of integrated solution sets that are retained for the composite interoperability score analysis.

39. The method of claim 38, wherein the composite interoperability score analysis includes a determination of function interactions between the plurality of functions in each function sequence in the plurality of activities in each activity sequence in each capability need from the set of operationally decomposed capability needs.

40. The method of claim of 39, wherein the composite interoperability score analysis includes a calculation of a plurality of interoperability scores for the integrated solution set in the plurality of integrated solution sets that are retained for the composite interoperability score analysis, wherein each of the interoperability scores in the plurality of interoperability scores is determined according to a measure of the ability of the one or more solutions that best satisfies the function corresponding to the function score to interoperate with each of one or more solutions that best satisfies the function corresponding to the function score for one or more functions for which there is a function interaction.

41. The method of claim 40, wherein the calculation of the plurality of interoperability scores for the integrated solution set in the plurality of integrated solution sets is a sum of the plurality of interoperability scores for the integrated solution set in the plurality of integrated solution sets.

42. The method of claim 40, wherein the calculation of the plurality of interoperability scores for the integrated solution set in the plurality of integrated solution sets is a ratio of a sum of the plurality of interoperability scores for the integrated solution set in the plurality of integrated solution sets to a sum of a plurality of maximum interoperability scores.

43. The method of claim 40, wherein the integrated solution set in the plurality of integrated solution sets is retained for a cost analysis if an outcome of the calculation of the plurality of interoperability scores for the integrated solution set in the plurality of integrated solution sets is above a composite interoperability score threshold.

44. The method of claim 43, wherein the integrated solution set in the plurality of integrated solution sets is selected for the subset of the plurality of integrated solution sets according to a cost-benefit optimization analysis.

45. The method of claim 44, wherein the optimization analysis includes a determination of whether the outcome of the calculation of the plurality of functionality scores is within a range of outcomes of calculations of the plurality of functionality scores, the outcome of the calculation of the plurality of interoperability scores is within a range of outcomes of calculations of the plurality of interoperability scores, and an outcome of the cost analysis is within a cost range.

46. The method of claim 44, wherein the optimization analysis includes a determination of whether the outcome of the calculation of the plurality of functionality scores is within a range of outcomes of calculations of the plurality of functionality scores and the outcome of the calculation of the plurality of interoperability scores is within a range of outcomes of calculations of the plurality of interoperability scores.

47. The method of claim 44, wherein the optimization analysis includes a determination of whether the outcome of the calculation of the plurality of functionality scores is within a range of outcomes of calculations of the plurality of functionality scores and an outcome of the cost analysis is within a cost range.

48. The method of claim 44, wherein the optimization analysis includes a determination of whether the outcome of the calculation of the plurality of interoperability scores is within a range of outcomes of calculations of the plurality of interoperability scores and an outcome of the cost analysis is within a cost range.

49. The method of claim 44, wherein the optimization analysis includes a determination of whether an outcome of the cost analysis is within a cost range.

50. The method of claim 40, wherein the integrated solution set in the plurality of integrated solution sets is retained for a risk analysis if an outcome of the calculation of the plurality of interoperability scores for the integrated solution set in the plurality of integrated solution sets is above a composite interoperability score threshold.

51. The method of claim 50, wherein the integrated solution set in the plurality of integrated solution sets is selected for the subset of the plurality of integrated solution sets according to a risk-benefit optimization analysis.

52. The method of claim 51, wherein the optimization analysis includes a determination of whether the outcome of the calculation of the plurality of functionality scores is within a range of outcomes of calculations of the plurality of functionality scores, the outcome of the calculation of the plurality of interoperability scores is within a range of outcomes of calculations of the plurality of interoperability scores, and an outcome of the risk analysis is within a risk range.

53. The method of claim 51, wherein the optimization analysis includes a determination of whether the outcome of the calculation of the plurality of functionality scores is within a range of outcomes of calculations of the plurality of functionality scores and an outcome of the risk analysis is within a risk range.

54. The method of claim 51, wherein the optimization analysis includes a determination of whether the outcome of the calculation of the plurality of interoperability scores is within a range of outcomes of calculations of the plurality of interoperability scores and an outcome of the risk analysis is within a risk range.

55. The method of claim 51, wherein the optimization analysis includes a determination of whether an outcome of the risk analysis is within a risk range.

56. The method of claim 40, wherein the integrated solution set in the plurality of integrated solution sets is retained for a cost analysis and a risk analysis if an outcome of the calculation of the plurality of interoperability scores for the integrated solution set in the plurality of integrated solution sets is above a composite interoperability score threshold.

57. The method of claim 56, wherein the integrated solution set in the plurality of integrated solution sets is selected for the subset of the plurality of integrated solution sets according to a cost-risk-benefit optimization analysis.

58. The method of claim 57, wherein the cost-risk-benefit optimization analysis includes a determination of whether the outcome of the calculation of the plurality of functionality scores is within a range of outcomes of calculations of the plurality of functionality scores, the outcome of the calculation of the plurality of interoperability scores is within a range of outcomes of calculations of the plurality of interoperability scores, an outcome of the cost analysis is within a cost range, and an outcome of the risk analysis is within a risk range.

59. The method of claim 57, wherein the cost-risk-benefit optimization analysis includes a determination of whether the outcome of the calculation of the plurality of functionality scores is within a range of outcomes of calculations of the plurality of functionality scores, and an outcome of the cost analysis is within a cost range, and an outcome of the risk analysis is within a risk range.

60. The method of claim 57, wherein the cost-risk-benefit optimization analysis includes a determination of whether the outcome of the calculation of the plurality of interoperability scores is within a range of outcomes of calculations of the plurality of interoperability scores, an outcome of the cost analysis is within a cost range, and an outcome of the risk analysis is within a risk range.

61. The method of claim 57, wherein the cost-risk-benefit optimization analysis includes a determination of whether an outcome of the cost analysis is within a cost range and an outcome of the risk analysis is within a risk range.

62. The method of claim 40, wherein the integrated solution set in the plurality of integrated solution sets is retained for an interoperability analysis if an outcome of the calculation of the plurality of interoperability scores for the integrated solution set in the plurality of integrated solution sets is above a composite interoperability score threshold.

63. The method of claim 62, wherein the integrated solution set in the plurality of integrated solution sets is selected for the subset of the plurality of integrated solution sets according to an interoperability optimization analysis.

64. The method of claim 34, wherein the integrated solution set in the plurality of integrated solution sets is retained for a functionality analysis if an outcome of the calculation of the plurality of functionality scores for the integrated solution set in the plurality of integrated solution sets is above a composite functionality score threshold.

65. The method of claim 64, wherein the integrated solution set in the plurality of integrated solution sets is selected for the subset of the plurality of integrated solution sets according to a functionality optimization analysis.

66. The method of claim 30, wherein the optimal integrated solutions set of existing solutions and emerging solutions is selected from the subset of the plurality of integrated solution sets according to a second order optimization analysis.

67. The method of claim 66, wherein the second order optimization analysis includes a determination as to whether each of the integrated solution sets in the subset of the plurality of integrated solutions sets satisfies one or more ranges of second order criteria.

68. The method of claim 67, wherein the one or more ranges of second order criteria include a level of performance that is measured according to one or more capability metrics.

69. The method of claim 68, wherein the level of performance is determined by utilizing a simulation on each integrated solution set in the subset of the plurality of integrated solution sets to estimate the one or more capability metrics for each integrated solution set in the subset of the plurality of integrated solution sets performing the function sequences and activity sequences in the operationally decomposed capability needs.

70. The method of claim 67, wherein the one or more ranges of second order criteria include a level of performance that is measured according to one or more capability metrics and a second order cost.

71. The method of claim 70, wherein the level of performance is determined by utilizing a simulation on each integrated solution set in the subset of the plurality of integrated solution sets to estimate the one Or more capability metrics for each integrated solution set in the subset of the plurality of integrated solution sets performing the function sequences and activity sequences in the operationally decomposed capability needs.

72. The method of claim 67, wherein the one or more ranges of second order criteria include a level of performance that is measured according to one or more capability metrics, a second order cost, and a second order risk.

73. The method of claim 72, wherein the level of performance is determined by utilizing a simulation on each integrated solution set in the subset of the plurality of integrated solution sets to estimate the one or more capability metrics for each integrated solution set in the subset of the plurality of integrated solution sets performing the function sequences and activity sequences in the operationally decomposed capability needs.

74. The method of claim 67, wherein the one or more ranges of second order criteria include a level of performance that is measured according to one or more capability metrics, a second order cost, a second order risk, and an implementation schedule.

75. The method of claim 74, wherein the level of performance is determined by utilizing a simulation on each integrated solution set in the subset of the plurality of integrated solution sets to estimate the one or more capability metrics for each integrated solution set in the subset of the plurality of integrated solution sets performing the function sequences and activity sequences in the operationally decomposed capability needs.

76. The method of claim 67, wherein the one or more ranges of second order criteria include a level of performance that is measured according to one or more capability metrics, a second order risk, and an implementation schedule.

77. The method of claim 76, wherein the level of performance is determined by utilizing a simulation on each integrated solution set in the subset of the plurality of integrated solution sets to estimate the one or more capability metrics for each integrated solution set in the subset of the plurality of integrated solution sets performing the function sequences and activity sequences in the operationally decomposed capability needs.

78. The method of claim 67, wherein the one or more ranges of second order criteria include a level of performance that is measured according to one or more capability metrics, a second order cost, and an implementation schedule.

79. The method of claim 78, wherein the level of performance is determined by utilizing a simulation on each integrated solution set in the subset of the plurality of integrated solution sets to estimate the one or more capability metrics for each integrated solution set in the subset of the plurality of integrated solution sets performing the function sequences and activity sequences in the operationally decomposed capability needs.

80. The method of claim 67, wherein the one or more ranges of second order criteria include a level of performance that is measured according to one or more capability metrics and an implementation schedule.

81. The method of claim 80, wherein the level of performance is determined by utilizing a simulation on each integrated solution set in the subset of the plurality of integrated solution sets to estimate the one or more capability metrics for each integrated solution set in the subset of the plurality of integrated solution sets performing the function sequences and activity sequences in the operationally decomposed capability needs.

82. The method of claim 67, wherein the one or more ranges of second order criteria include a level of performance that is measured according to one or more capability metrics and a second order risk.

83. The method of claim 82, wherein the level of performance is determined by utilizing a simulation on each integrated solution set in the subset of the plurality of integrated solution sets to estimate the one or more capability metrics for each integrated solution set in the subset of the plurality of integrated solution sets performing the function sequences and activity sequences in the operationally decomposed capability needs.

84. The method of claim 67, wherein the one or more ranges of second order criteria include a second order cost, a second order risk, and an implementation schedule.

85. The method of claim 67, wherein the one or more ranges of second order criteria include a second order cost and a second order risk.

86. The method of claim 67, wherein the one or more ranges of second order criteria include a second order cost and an implementation schedule.

87. The method of claim 67, wherein the one or more ranges of second order criteria include a second order cost.

88. The method of claim 67, wherein the one or more ranges of second order criteria include a second order risk and an implementation schedule.

89. The method of claim 67, wherein the one or more ranges of second order criteria include a second order risk.

90. The method of claim 67, wherein the one or more ranges of second order criteria include an implementation schedule.

91. The method of claim 1, wherein each of the operationally decomposed capability needs in the set of operationally decomposed capability needs includes a plurality of potential activity sequences.

92. The method of claim 91, wherein each of the plurality of potential activity sequences includes a plurality of potential function sequences.

93. The method of claim 92, wherein the optimal integrated solution set of existing solutions and emerging solutions is selected from a plurality of optimal integrated solution sets that best satisfy each of the plurality of potential function sequences in each of the plurality of potential activity sequences.

94. A method of enhancing capabilities, comprising:
conducting family of systems capability and operational analysis that generates a set of operationally decomposed capability needs;
conducting family of systems functional analysis and allocation on the set of operationally decomposed capability needs to determine a set of deficiencies;
conducting family of systems design synthesis on the set of operationally decomposed capability needs, a set of existing solutions, and a set of emerging solutions;
creating a plot from the family of systems design synthesis that illustrates one or more desirable integrated solution sets of existing solutions and emerging solutions; and
determining an optimal integrated solution set of existing solutions and emerging solutions, from the plot, to satisfy the set of operationally decomposed capability needs.

95. (canceled)

96. (canceled)

97. (canceled)

98. (canceled)

99. (canceled)

100. (canceled)

101. (canceled)

102. (canceled)

103. The method of claim 101, wherein for each of the functions, the family of systems functional analysis and allocation determines which, if any, of the emerging solutions can provide the function.

104. (canceled)

105. The method of claim 104, further comprising composing a plurality of integrated solution sets, wherein each of the plurality of integrated solutions sets includes one of the emerging solutions or one of the existing solutions that can provide each function.

106. The method of claim 105, wherein the optimal integrated solutions set of existing solutions and emerging solutions is selected from the plurality of integrated solutions sets based on the plot.

107. The method of claim 105, wherein a subset of integrated solutions sets is selected from the plurality of integrate solutions set according to a first order analysis of the plot.

108. The method of claim 107, wherein the optimal integrated solutions set of existing solutions and emerging solutions is selected from the subset according to a second order optimization analysis.

109. A method of enhancing capabilities, comprising:
conducting family of systems capability and operational analysis that generates a set of operationally decomposed capability needs;
conducting family of systems functional analysis and allocation on the set of operationally decomposed capability needs to determine a set of deficiencies;
conducting family of systems design synthesis on the set of operationally decomposed capability needs, a set of existing solutions, and a set of emerging solutions;
creating a matrix from the family of systems design synthesis that illustrates one or more desirable integrated solution sets of existing solutions and emerging solutions; and
determining an optimal integrated solution set of existing solutions and emerging solutions, from the matrix, to satisfy the set of operationally decomposed capability needs.

110. (canceled)

111. (canceled)

112. (canceled)

113. (canceled)

114. (canceled)

115. (canceled)

116. (canceled)

117. (canceled)

118. The method of claim 116, wherein for each of the functions, the family of systems design synthesis determines which, if any, of the emerging solutions can provide the function.

119. (canceled)

120. The method of claim 119, further comprising composing a plurality of integrated solution sets, wherein each of the plurality of integrated solutions sets includes one of the emerging solutions or one of the existing solutions that can provide each function.

121. The method of claim 120, wherein the optimal integrated solutions set of existing solutions and emerging solutions is selected from the plurality of integrated solutions sets based on the matrix.

122. The method of claim 120, wherein a subset of integrated solutions sets is selected from the plurality of integrate solutions set according to a first order analysis of the matrix.

123. The method of claim 122, wherein the optimal integrated solutions set of existing solutions and emerging solutions is selected from the subset according to a second order optimization analysis.

124. A method of enhancing capabilities, comprising:
creating an architecture model of an operating environment;
conducting family of systems capability and operational analysis on data from the architecture model using simulation and analysis to generate a set of operationally decomposed capability needs;
conducting family of systems functional analysis and allocation on the set of operationally decomposed capability needs and data from the architecture model using simulation and analysis to determine a set of deficiencies;
conducting family of systems design synthesis on the set of operationally decomposed capability needs, a set of existing solutions, a set of emerging solutions, and data from the architecture model using simulation and analysis to identify and describe an optimal integrated solution set of existing solutions and emerging solutions to satisfy the set of operationally decomposed capability needs; and
generating the optimal integrated solution set of existing solutions and emerging solutions from the family of systems design synthesis.

125. (canceled)

126. (canceled)

127. (canceled)

128. (canceled)

129. (canceled)

130. (canceled)

131. (canceled)

132. (canceled)

133. The method of claim 131, wherein for each of the functions, the family of systems design synthesis determines which, if any, of the emerging solutions can provide the function.

134. (canceled)

135. The method of claim 134, further comprising composing a plurality of integrated solution sets, wherein each of the plurality of integrated solutions sets includes one of the emerging solutions or one of the existing solutions that can provide each function.

136. The method of claim 135, wherein the optimal integrated solutions set of existing solutions and emerging solutions is selected from the plurality of integrated solutions sets based on a set of criteria.

137. The method of claim 135, wherein a subset of integrated solutions sets is selected from the plurality of integrate solutions set according to a first order analysis.

138. The method of claim 137, wherein the optimal integrated solutions set of existing solutions and emerging solutions is selected from the subset according to a second order optimization analysis.
